(19) United States
(12) Patent Application Publication
(10) Pub. No.: US 2005/0153026 A1
(43) Pub. Date: Jul. 14, 2005

(54) Suspended containers

(76) Inventors: Jeffrey T. Mannion, South Burlington, VT (US); John N. Williams, Boston, MA (US)

Correspondence Address: FISH & RICHARDSON PC, 225 FRANKLIN ST, BOSTON, MA, 02110, US

(21) Appl. No.: 10/983,975

(22) Filed: Nov. 8, 2004

Related U.S. Application Data
(63) Continuation of application No. PCT/US03/14175, filed on May 6, 2003.
(60) Provisional application No. 60/399,195, filed on Jul. 29, 2002.
(60) Provisional application No. 60/397,329, filed on Jul. 18, 2002.
(60) Provisional application No. 60/378,399, filed on May 6, 2002.

(51) Int. Cl. A23B 4/00

(52) U.S. Cl. 426/110

(57) ABSTRACT

Suspender units of various forms for containers. Unit has a supporting ring (18) constructed to be connected with the rim of the container and a suspender (16, 16a-f, 96, 121, 121a-b, 162, 162a-c, 12d-e, 200, 204,262, 270). Suspender lies parallel with and along or between limiting planes of the ring. In important cases, suspender is molded of resin simultaneously with molding the ring, and an integral mouth-sealing surface while in other important cases the ring surrounds and is integrated with a central insert (12, 12a-c, 13, 13a, 104, 130, 161, 206, 220, 222, 222a-b) as by insert-molding, the insert carrying the suspender. Suspender is deflectable from a formed position to an upstanding position in which it is capable, via the ring, of carrying weight of the container and goods. Finger suspender (16) is joined to connector at a location (R) substantially offset from central axis of the package.

### CLAIM OF PRIORITY

This application is a continuation under 35 USC §120 of PCT Application Serial No. PCT/US03/14175, filed on May 6, 2003, which claims the benefit of U.S. Provisional Application Ser. No. 60/399,195, filed Jul. 29, 2002, and claims the benefit of U.S. Provisional Application Ser. No. 60/397,329, filed Jul. 18, 2002, and which also claims the benefit of U.S. Provisional Application Ser. No. 60/378,399, filed May 6, 2002. The entire contents of which are herein incorporated by reference.

### TECHNICAL FIELD

This invention, in some aspects, is an improvement employing general concepts described in our pending applications U.S. application Ser. No. 10/052,210, filed Jan. 16, 2002 and PCT Application Serial Number US02/01112, filed Jan. 16, 2002, the entire contents of which being herein incorporated by reference. In other aspects, the invention represents further advantageous features in the design, construction and handling of disposable containers and the like.

### BACKGROUND

In the above-referenced patent applications we present the concept of a closure for a wide-mouth container, that has a ring secured to a rim of the container, and a suspender, or a pair of such suspenders, integrated with and extending from the lid structure for sales display and convenient handling by a customer or user. The strength of the connection between lid and container enables the weight of the container to be borne by a finger, via the structure of the lid.

In many preferred forms, the suspender, as originally formed, lies substantially between horizontal planes bounding the top and bottom extremities of the overall lid, e.g. for easy stacking and packing of the lids or containers to which the lids have been applied. The suspender is constructed to flex or fold outwardly to be grasped by a finger of the user for transport or display. It can fold back to its original orientation in cases where it is applied to the end of the container on which the container is intended to rest.

Advantageously, in preferred embodiments, a ring of the lid is molded of thermoplastic, synthetic resin, and has a portion that is engaged with a relatively rigid rim of the container.

The invention is of particular importance with respect to flat lids with molded rims for wide-mouth containers, i.e. lids having a rim height no more than about 20% of the wide dimension of the closing surface of the rim of the lid.

### SUMMARY

The invention provides a flexible suspender unit for a product container in which the suspender is integrated with an attachment ring (e.g. snap, friction or screw-on ring) that attaches to the mouth portion of the container. The suspender is integrally molded with the attachment ring or is separately formed and integrated with the attachment ring as an insert. In many preferred cases the unit serves a sealing function, a sealing layer element being molded of resin as part of the unit, or provided as an insert about which the rim of the unit-is molded or applied subsequent to forming the other parts. In many preferred cases, the attachment ring is fabricated about the insert as by insert injection molding of the ring about the insert, or the suspender unit is otherwise formed so that forming the attachment ring occurs in a last forming stage. In other preferred cases the suspender is integrated with a preformed ring, such as a pre-molded or formed ring or a completed lid with ring.

The invention also concerns advantageous inserts and methods of forming inserts for the above purposes. The invention also concerns advantageous suspender unit constructions, and sales displays employing the product.

According to one aspect of the present invention, it is realized that insert injection molding techniques can also be adapted to advantage for constructing suspender units, and especially suspender units that have product sealing and visualization characteristics. In particular we refer to U.S. Pat. Nos. 3,397,814; 3,956,550; 3,973,689; 4,096,963; 4,211,336 and 4,238,047. Also see U.S. Pat. Nos. 5,647,501; 6,053,353; 6,196,451, the pertinent prior art patents specifically listed in column 1 of each of those patents, and those listed in those patents as “references cited” by the U.S. Patent Office. Each and every one of these patents referred to above are hereby incorporated by reference.

Techniques useful for applying materials to preformed rings are shown in U.S. Pat. No. 5,911,334, in the prior art patents specifically listed in the body of that patent, at column 1, and in that patent as “references cited” by the U.S. Patent Office. Each and every one of the above referred to patent applications and patents are hereby also incorporated by reference.

According to one aspect of the invention, a suspender unit for attachment to a container is provided comprising an attachment ring formed for attachment to the mouth portion of the container and a suspender is integrated with the ring or lid. In preferred embodiments the ring surrounds and is secured to an insert, the insert defining a deflectable suspender, preferably in most cases, a finger suspender, that may be raised from the general plane of the ring for suspending the container.

Preferred embodiments of these important aspects of the invention have one or more of the following features:

The suspender unit is formed about the insert, which preferably includes a supporting rim, preferably the unit comprising an insert injection molded unit.

The suspender is secured beneath an inwardly extending flange or formation of the ring, or above an inwardly extending surface of the ring.

The insert is joined to a preformed ring.

The suspender unit is associated with a sealing layer or element below the suspender that seals the opening defined by the ring; in preferred embodiments the sealing layer or element comprises part of the insert, and/or the sealing layer or element comprises transparent material and the suspender and/or a supporting rim surrounding the suspender is shaped to expose an area of the sealing layer or element to view when the unit is attached to the container, e.g. the suspender defines a supporting opening that is sized for viewing the sealing layer or element.

The sealing layer or element is transparent enabling view of the contents of the container.

The deflectable suspender is an elongated cantilever extending from a root region, preferably the root region located adjacent the rim.

The deflectable suspender is of length exceeding one half the dimension of the attachment ring in the direction of extent of the suspender.

The deflectable suspender is at least 2 inches in length.

The deflectable suspender is a finger suspender.

The deflectable suspender is of cantilever form and includes a root region by which it is joined to a support, an elongated leg, and an enlarged distal head defining a support opening.

The suspender is of bail form extending from spaced apart root regions.

Preferred embodiments also have one or more of the following features:

The attachment ring is a snap ring constructed to snap about or with a mating formation on the associated container.

The suspender unit includes a restraint constructed to temporarily restrain the deflectable suspender to the general plane of the ring and to enable the suspender to be deflected to suspending position, preferably the restraint comprising restraining tabs, strands or adhered points constructed to be ruptured to release the suspender, or a ledge that retains the suspender, but from which it can be released.

The restraint comprises a formation fixed relative to the rim extending over a deflectable portion of the suspender in releasable restraining relationship, in preferred embodiments the formation being an inward protrusion from the attachment ring or a complex surrounding flange sized to enable flexing or shortening of the suspender to enable it to escape from under the protrusion or flange.

The deflectable suspender is of flexible material, adapted to flex along its length.

The deflectable suspender is generally of sheet form, or of molded form.

The deflectable suspender is die-cut from flexible sheet material or from a preformed lid.

The deflectable suspender is secured to a top closure wall formed with the attachment ring.

According to another aspect of the invention, a method is provided of forming an insert for insert molding of a closure ring or for securing to a preformed ring of a detachable packaging lid, comprising forming a deflectable suspender which includes a surrounding rim for joining to the attachment ring.

In preferred embodiments the method includes joining a sealing layer below the deflectable suspender and cutting the deflectable suspender from preformed sheet material.

According to another aspect of the invention a lid for attachment to a container is provided of multiple-part construction, in which the ring of the lid is defined by one component and a separately formed component defining a suspender and its mounting base is permanently joined to the ring or lid section inwardly of the ring as by fusing, adhesively adhering, snap fitting or other joining techniques, to the underside or to the top side of the ring or lid section.

In one embodiment, the ring is a molded hollow annular snap ring, and a matching, inwardly extending annular margin of the hollow ring is permanently joined to a matching peripheral margin or base of a suspender-defining center member. The center member may be formed of the same material as the ring, e.g. of molded plastic. In this case, the parts may be joined by ultrasonic welding, heat fusing or staking together, employing well-known self-adhesive principles, or by an adhesive that is compatible with the resin of the ring and the resin of the center member. In certain instances, for achieving a strong bond, the resin of the ring and the center member are of the same type to enable choice of an optimum adhesive. In other advantageous cases, the center member may be defined of a material having markedly different properties from that of the ring, for instance the ring being of molded resin, paper textile or composite material and the center member of plastic, chip board or card stock or of other paper, paper-plastic laminate, textile or composite materials. In some embodiments the ring component has a continuous, seal-forming top surface section molded integrally with the ring, and a further top or center member forming the suspender has its wide area base secured, as by heat sealing or other adhesive technique, to that extended top surface, or the center member is adhesively or mechanically captured at its edge margin only. In other cases a sealing insert, e.g. a sealing film or a die cut piece is secured below the component defining the suspender, to ensure that the lid forms a complete seal with the container.

In one embodiment, the component that carries the finger suspender includes a rigid disc that is snap fit into a mated recess defined by an elastic ring, while another recess of the ring is snap fit, in conventional fashion, over the edge bead of the container.

The rings of the suspender unit may have any of various conformations to form mechanical and sealing connection with the rim of the container, including ring conformations to form outer or inner seals or combinations of outer and inner seals with the container wall, or connections to the container that have tamper-evident features, e.g., sections of ring that must be broken away to enable pull-off of the ring to permit initial access to the interior of the container.

According to another feature of the invention, a molded lid or mounting ring has a molded center configuration in the form of a sinuous cord of the same molded material as that forming the ring. The cord is molded at the same time as the ring, as a single unit, the cord, as molded, lying between the parallel bounding planes of the upper and lower surfaces of the rim. This cord is configured and arranged to be pulled outwardly to define an elongated suspender. In some preferred embodiments, the cord has such length in its serpentine configuration that, when distended, it may reach a distance as great as the diameter of the ring or more from the upper plane of the ring, enabling attachment of the container to desired supports that are otherwise inaccessible, or enabling interlinking of a series of containers by threading one suspended or through another and so on.

In certain embodiments, the cord extends from one root region where it joins the ring, to a root region on the ring that is located across the diameter of the ring. In other embodiments, the cord extends in serpentine fashion from a first root region for a considerable distance, but makes its way back to a second root junction adjacent the first. Symmetrical and asymmetrical cord patterns have advantages, with widened formations of the cord at regions where it is expected that the load will be applied.

In certain preferred embodiments, the serpentine cord, as molded, extends freely between its roots, with open space between adjacent sections of the cord. In other preferred embodiments, thin, molded membrane sections extend between adjacent sections of the cord, and between the rim and adjacent sections of cord, so that the entire area bounded by the rim is closed, and the lid can perform a sealing function when engaged with its container. These thin membrane sections are sufficiently thin and weak, that pulling on the cord to distend it for suspending the container ruptures the membrane sections and enables the cord to be pulled free.

Another aspect of the invention is a lid having a mounting ring, and molded integrally with the ring or an inward extension of it is a molded flexible or living hinge to which a suspender element is joined, the suspender element, in its as-molded configuration, lying within the upper and lower bounding planes of the rim, but being deflectable to a suspending position.

According to another aspect of the invention, a suspender-defining element is secured to a permanently closed end of a container, for instance to the end of the container opposite that of a wide mouth or other opening, and the opening is closed by another snap member, which in some cases, may, as well, define a further suspender member. Suspender members extending from both ends of a container enable the container to be mounted between spaced apart posts that are engaged with the suspender members. In some cases, the suspender member enables carrying of a container bottom-side-up, for instance a tub of popcorn or fried chicken, and when reaching the destination, the container is inverted and opened from the end opposite to the end from which the suspender protrudes. A suspender, provided, as a bottom closure molded of plastic resin, may be useful in preventing transfer of grease or other contents of the container.

In certain embodiments, plastic, paper or mesh containers are terminated at both ends by resilient, open end rings closed by snap-in end lids of relatively rigid construction which may (or in some cases may not) also define finger suspenders, as described. Such constructions facilitate unique compact disposal of the package after use, by removal of the end lids and crushing the side walls flat together into a more dense disposable mass. Here again, the adequacy of a snap fit container joint to bear the weight of the contents, for instance at the bottom of the container on which rests, for instance the weight of a bucket of fried chicken, is taken advantage of to provide a significant advance in disposable packaging.

According to still another aspect of the invention, each end of a container, e.g. a cylindrical or conical container, or one of rectangular or triangular cross section, is provided with a finger suspender, e.g. each secured by its own integral snap ring. This enables unique display and handling of awkward or heavy items, including flexible, tubular bags, such as of mesh carrying onions or grapefruit, that terminate in rigid rings to which the suspender rims are snap fit.

The invention further provides improvement in the packaging of bottled water, toothpaste, and many other consumer items, with advantages of suspension and disposability of a kind not previously known.

According to another aspect of the invention, a method of forming a suspender unit for a container is provided, comprising forming a central insert defining a flexible suspender lying substantially in a plane of the insert and deflectable to a raised suspending position, the suspender secured to a supporting rim, and forming an attachment ring about the insert, the attachment ring constructed to join the unit to the mouth portion of a container.

Preferred embodiments of this aspect of the invention have one or more of the following features:

The method of forming the attachment ring comprises insert injection molding. Forming the insert includes forming restraining tabs, filaments weld or adhesive tack points, or a retaining protrusion of flange that serve to retain temporarily the suspender in its as-formed condition.

The insert is formed as a clamshell, which is folded together.

According to another aspect of the invention a method of molding a suspender unit or an insert in a clamshell form is provided, one side of the clamshell mold defining a deflectable suspender and the other side defining a structure against which, following molding, the suspender is folded and joined.

In some preferred embodiments of this aspect of the invention, the molded and folded clamshell article comprises an insert about which subsequently an attachment ring is molded or otherwise formed; in other embodiments the molded structure includes the attachment ring.

The details of embodiments of various aspects of the invention are set forth in the accompanying drawings and the description below. Other features, objects, and advantages of the invention will be apparent from the foregoing and following descriptions and drawings, and from the claims.

### DESCRIPTION OF DRAWINGS

FIG. 1 is a diagrammatic side view of an injection molding station to which a suspender insert of various types is introduced, about which an attachment ring is molded by insert injection molding.

FIG. 1a is a view on an enlarged scale of a preferred embodiment of FIG. 1 in which the insert is of a two-layer construction comprising a top layer defining a deflectable suspender and below it a sealing layer.

FIG. 2 is a generalized plan view of a suspender insert lying in the plane of its base while FIG. 2a is a perspective view of the deflectable suspender raised from its base.

FIG. 3 is a side cross-sectional view of a suspender insert formed as a single layer while FIG. 3a is a similar view showing the insert molded in a snap ring adapted to be snap-fit to the top of a container shown in phantom lines.

FIGS. 3b-3h are cross sections illustrating various insert-molded constructions in which the insert lies below a molded element.

FIG. 4 is a view similar to FIG. 3 of an insert in which the deflectable suspender, as a discretely formed member, has been integrated with a sealing, supporting disc, while FIG. 4a is a partial cross-sectional view similar to FIG. 3a showing a snap ring-suspender unit formed with the insert of FIG. 4.

FIG. 4b is a view similar to parts of FIG. 4 of an alternate construction of a discretely formed suspender.

FIG. 5 is a view similar to FIG. 3 of a two-layer suspender insert, such as shown in FIG. 1a, while FIG. 5a is a cross-sectional view showing the insert of FIG. 5 molded in a snap ring.

FIGS. 5b, 5c and 5d are vertical cross-sections of suspender units in which the suspender insert is insert molded to the top of a closure.

FIG. 6 is a plan view similar to FIG. 2 of an alternate construction having an enlarged viewing window through the suspender opening.

FIG. 7 is a diagrammatic side view of a suspender insert forming machine while FIG. 7a is a diagrammatic plan view of a continuous strip that can be formed by the system of FIG. 7.

FIG. 8 is a diagrammatic side view similar to FIG. 7 of another suspender insert forming machine while FIG. 8a is a view similar to FIG. 7a of a strip that can be formed by the system of FIG. 8.

FIGS. 9 and 9a are diagrammatic views of a molding system during stages of molding a suspender insert.

FIG. 10 is a diagrammatic side view of a suspender element and a sealing layer molded as a unit, while FIGS. 10a and 10b illustrate the parts of the unit of FIG. 10 joined together.

FIGS. 11-18 are perspective views of suspender inserts suitable for insert injection molding of attachment rings to form suspender units.

FIG. 19 is a perspective view of a finished suspender unit.

FIG. 20 is a view similar to FIG. 9 of a suspender unit forming mold, for forming a suspender ring and sealing surface simultaneously while FIG. 20a is a side cross-section of the unit as it comes from the mold, FIG. 20b shows the unit with the deflectable suspender at the plane of the ring and FIG. 20c shows the deflectable suspender in its use position.

FIG. 21 is a perspective view illustrating disc elements forming finger suspenders being die cut from a continuous sheet of paperboard stock, to the undersurface of which a continuous layer of heat-activatable adhesive has been pre-applied, as by knife coating or co-extrusion.

FIG. 21a is a cross-section on an enlarged scale of a portion of a vertical cross-section of the material shown in FIG. 21.

FIG. 21b is a plan view of the die-cut top formed from the material of FIGS. 21 and 21a.

FIG. 22 is a perspective view of a suspender associated with a molded rim for a lid, having a formation for elastically gripping and securing a matching, relatively rigid rim of a wide-mouthed container.

FIG. 22a is a cross-section taken on line 22a-22a of FIG. 22, showing the center member of FIG. 21b secured in place, and illustrating in partial lines a container to which the rim has been secured.

FIG. 22b diagrammatically illustrates the integrating of the center member of FIG. 21b and the rim of FIG. 22 under heat and pressure, to form a suspender unit.

FIG. 23 illustrates a lid, as described, with the finger suspender lying between upper and lower planes of the lid rim, joined to the underside of the rim.

FIG. 23a is a top view of the lid of FIG. 23.

FIG. 23b is a perspective view of the assembly of FIG. 23, with the suspender deflected to upright position, being engaged by the finger of a person.

FIG. 24 is a cross section of a plastic molded annular ring of a lid, having an inwardly extending flange, and a circular chipboard insert having its outer margin adhered to the underside of the flange of the ring, the insert having a folded, free-ended suspender of chipboard lying within the bounding planes of the lid.

FIG. 24a is a top view of the lid of FIG. 24; FIG. 24b is a perspective view showing the finger suspender in distended position while FIG. 24c shows the chipboard insert prior to the finger suspender being folded to the position shown in FIG. 24.

FIG. 25 shows a molded plastic snap ring of annular form, with inwardly extending flange, to the underside of which a die cut disc is adhesively applied, the disc including a circular chip board piece having a die-cut semi-circular fold-up handle, and, on the underside of the whole chip board cut out, a sealing film laminated about its circular margin to the chipboard (not to the handle), while FIG. 25a is a top view of the lid of FIG. 25 and FIG. 25b is a perspective view of the lid of FIG. 25, with the handle folded into position for use, while the seal remains in tact.

FIG. 26 is a vertical cross-sectional view of a lid having a semi-circular handle 12 molded of the same resin as, and simultaneously with, snap ring, being joined thereto by diametrically opposite hinge regions, while FIG. 26a is a top view of the lid of FIG. 26, and FIG. 26b is a perspective view showing the handle flexed to suspending position. To the underside of an inwardly extending flange of the ring is adhered a sealing insert which may be a sealing film, a sealing chipboard printed insert or a combination thereof.

FIG. 27 is a view, similar to FIG. 26, of another molded rim and handle arrangement, in this case two arcuate handles extending inwardly to the center from root joining sections 20 that are offset from an axis of symmetry adjacent the most inward protrusion of the two handles. FIG. 27a is top view of the lid of FIG. 27 and FIG. 27b is a perspective showing the handles in their distended position. A sealing insert similar to that of FIG. 27 is shown in place.

FIG. 28 is a vertical cross section of a molded snap ring lid having a continuous molded closing surface extending across the top. To the upper surface of the top is adhered a chipboard die cut piece having two free-ended finger suspenders in inward, flat folded condition, lying within the upper and lower bounding planes of the lid. FIG. 28a shows in plan view the chipboard piece before the suspenders have been folded to the position shown in FIG. 28. When desired, these suspenders are folded upwardly along the dotted paths suggested in FIG. 28.

FIG. 29 is a vertical cross-section and FIG. 29a is a plan view of a molded plastic lid as shown in FIG. 28, to the top surface of which is adhered a circular chipboard member defining a handle, joined at diametrically opposite hinge regions. All but the underside of the handle has the adhesive, as suggested in FIG. 29b. In FIG. 29c a perspective shows the handle in extended position.

FIG. 30 is similar to FIG. 23, except that instead of a finger suspender, a hanging tab, of lesser length than the finger suspender is die-formed in the chipboard disc. The disc is adhered to sealing film in all regions excepting under the tab. FIG. 30a is a top view of the lid of FIG. 30, while FIG. 30b illustrates an alternative position for the tab 12e, nearer the center, and FIG. 30c is a perspective view showing the tab in its outwardly bent position, serving to support a container. FIG. 30d is a view similar to FIG. 30, of a plastic molded lid, in which the tab is formed in a top surface of molded plastic and a sealing film is adhered beneath to seal the region of the tab.

FIGS. 31, 31a, 32, 32a and 33 are top views of respectively different molded lids that incorporate a molded cord of serpentine configuration lying between the upper and lower bounding planes of a molded lid. FIGS. 31b and 32b are vertical cross sections respectively of the lids of FIGS. 31a and 32a, and FIGS. 31c and 32c are side views, respectively, of the two lids.

FIG. 33a is a vertical cross-section of the molded lid of FIG. 33.

FIG. 33b is a side view of an insert forming system by which preformed suspension cord is applied to a sealing layer to provide an insert for a flat lid, while FIG. 33c is a plan view of the substrate being sewn and formed, FIG. 33d is a plan view of an insert that has been cut from the material formed in FIGS. 33b and 33c and FIG. 33e is a greatly magnified view illustrating the cord lightly sewn to a supporting layer.

FIG. 33f is a diagrammatic perspective view similar to that of FIG. 33d of a flat strap in a reversely coiled condition to illustrate the utilization of such flat strap as that illustrated in FIG. 33d.

FIG. 33g is a perspective view of an insert similar to that depicted in FIG. 33d.

FIG. 33h is a flat lid or overcap formed by a molded ring and the insert of FIG. 33g either by insert injection molding or by application of the insert of FIG. 33g to a preformed ring.

FIG. 33i is a cross-sectional view of the ring of FIG. 33h showing in dashed lines a distended position of the cord

FIG. 33j is a highly magnified, cross-sectional view similar to that of FIG. 33e showing cord segments at the outer periphery of the insert of FIG. 33g being integrated with molded resin of the injection molded ring.

FIG. 34 illustrates one advantageous use of lids formed according to FIGS. 31-33, the convenient carrying of multiple tennis ball cans by the same hand that carries a racket.

FIG. 35 illustrates a suspender unit having a retaining ledge for temporarily restraining a suspender while FIG. 35a is an exploded view and FIG. 35b is a vertical cross-section of the unit.

FIG. 35c is a perspective view similar to FIG. 35 of an alternate construction.

FIG. 36 is a plan view of a suspender unit in which the suspender element, formed, e.g., by the machine of FIG. 7 is integrated with a preformed closure lid as illustrated in FIG. 22b.

FIG. 37 is a view similar in type to FIG. 1a of an insert injection molding station for a flat lid in which an insert is a sealing layer that carries or defines additional functional or decorative features.

FIG. 38 is a perspective view of a preformed sealing for injection molding carrying a disc-form “antibond” layer while FIG. 38a is a partially cut-away perspective view of a flat snap lid formed by injection molding with the insert of FIG. 38.

FIG. 39 is a plan view of a sealing insert similar to that depicted in FIG. 38, indicating an alternate antibond pattern, while FIG. 39a is a perspective view of a “tear loose” finger suspender overlying the sealing insert of FIG. 39 and FIG. 39b is a vertical cross-sectional view of the lid of FIG. 39a.

FIG. 40 is a perspective view of a sealing insert having a pattern of temporary retaining formations for a finger suspender, while FIG. 40a is a perspective view of a flat lid formed by insert injection molding with the insert of FIG. 40.

FIG. 41 is a perspective view of another insert, while FIG. 41a is a vertical cross-section of a flat lid formed with the insert of FIG. 41.

FIG. 42 is a plan view of a sealing insert having a strategically located resin flow aperture and a patterned antibond layer, FIG. 42a is a vertical cross-section of an insert injection molded flat snap lid having a finger suspender formed with the insert of FIG. 42, FIG. 42b is a perspective view of a preferred form of the insert of FIG. 42 employed in the lid of FIG. 42a and FIG. 42c is a cross-section of a mold forming the lid of FIG. 42a.

FIG. 43 is a plan view similar in some respects to FIG. 40 of a sealing insert having inductively heatable spots of adhesive, FIG. 43a is a vertical side view of the insert of FIG. 43, while FIG. 43b is a vertical side view of a flat lid being formed with the insert of FIG. 43.

FIG. 44 is a plan view of a sealing insert having out-lying finger suspenders, while FIG. 44a depicts one type of lid moldable with the insert of FIG. 44.

FIG. 44b is a plan view of an insert similar to FIG. 44 having strategically located resin flow apertures and fold lines for bending to a desired orientation in the mold, while FIG. 44c is a view similar to FIG. 44a showing the lid as molded, but also showing the finger suspenders in use with tab portions bent about lines also shown in FIG. 44b.

FIG. 45 is a perspective view of a molded flat lid having an integrally molded undulating, expansible central strut defining a central finger support hole.

FIG. 46 is a view similar in type to FIG. 45 of a flat lid having integral flexible, co-planar hanging tabs protruding into open space from the sides of a molded central strut, while the side section view of FIG. 46a, taken on lines of 46, illustrate flexing of the hang tabs to hanging position.

FIG. 47 is a view similar in type to FIG. 46 of a hang tag similar in some respects to that of FIG. 46, but protruding inwardly from the rim region of the lid.

FIG. 48 is a view similar to FIG. 45, of a central strut in which a small, central flexible hanging tab is formed.

FIG. 49 is a view similar to FIG. 19 illustrating deflection of a molded finger tab relative to its molded supporting leg.

FIG. 50 is a perspective view of a sealing insert carrying on its upper surface a flattened decorative bow, while FIG. 50a is a vertical cross-section of a flat lid into which the insert of FIG. 50 has been integrated and FIG. 50b is a perspective view of the lid of FIG. 50a with the bow expanded. FIG. 50c is a view similar to FIG. 50a of a protective feature.

FIG. 51 is a perspective view of a lid insert carrying a preformed hologram, while FIG. 51a is a vertical cross-section of a flat lid into which the insert of 51 is integrated.

Like reference symbols in the various drawings indicate like elements.

### DETAILED DESCRIPTION

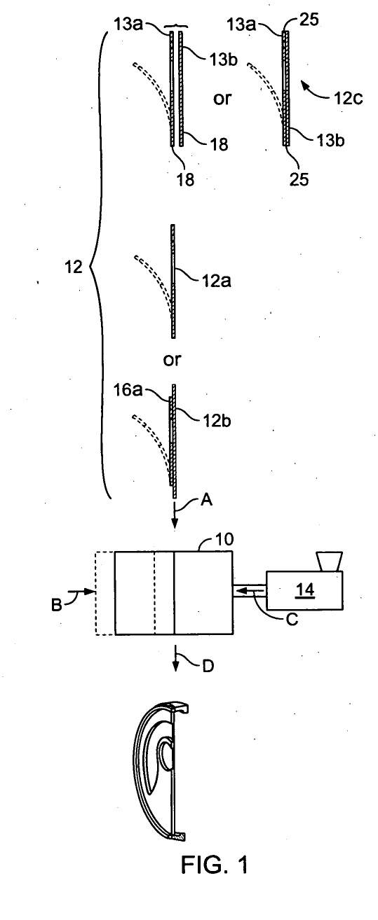

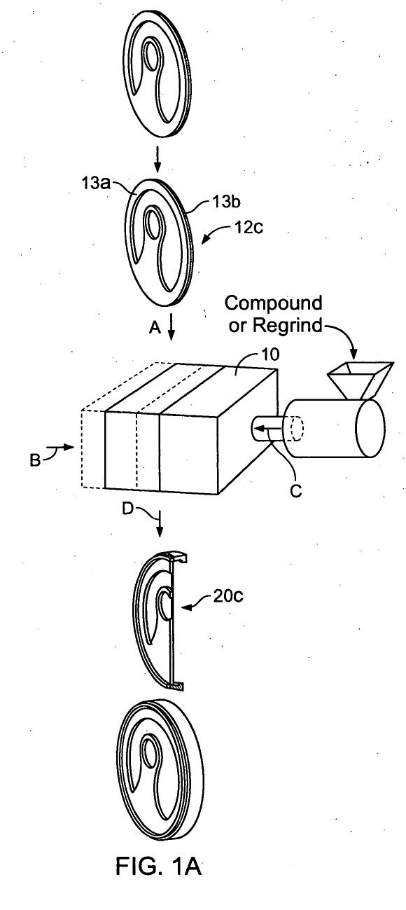

Referring to FIG. 1, an insert injection molding system for forming a snap ring of synthetic resin is shown. Mold 10 is operated between closed (solid line) and open dashed line) positions. During each mold cycle a preformed suspender insert 12, shown diagrammatically in various selectable forms in FIG. 1, is automatically placed in the open mold, in a motion symbolically indicated by arrow A, using known insertion techniques. The mold is then closed, arrow B, suitable molten resin is injected into the mold by injection molding system 14, arrow C, the mold is opened to the dashed-line position and the molded article removed, arrow D. Removal can be caused conventionally, for instance by ejector pins (not shown), that enable the molded lid to be freed and fall from the mold by gravity, to be fed in conventional way to conventional lid-stacking or handling equipment.

The preformed insert 12 preferably has one of a number of novel constructions depending upon the intended use for the suspender unit, and may have various peripheral forms depending upon the shape of the container with which the lid is desired to be used, for instance, round, oval, rectangular or square, with or without rounded corners, triangular, etc.

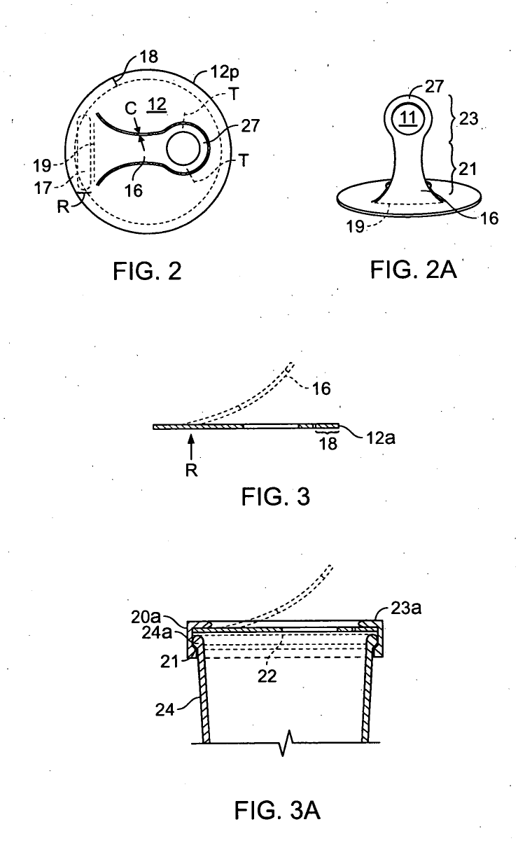

The inserts are shown round for convenience of illustration, and because many times preferred round mouthed containers such as disposable coffee cups or tennis ball cans are employed with the invention. For instance in FIG. 2 the insert has a circular periphery 12p and peripheral rim portion 18. It carries in its mid region a flexible suspender extending from root R near the periphery. The deflectable suspender, here shown is in the form of an elongated finger suspender 16 of cantilever form having elongated leg 21 and enlarged distal head 23 defining an opening 11 sized to receive a finger. The deflectable portion exceeds half the dimension of the insert in length, in many advantageous cases being about 2 inches or more in length.

In FIG. 2, the preferred finger suspender 16 is shown in its as-formed position in the plane of the rim 18, while in FIG. 2a the deflectable suspender 16 is shown in its flexed, upright finger-supportable position.

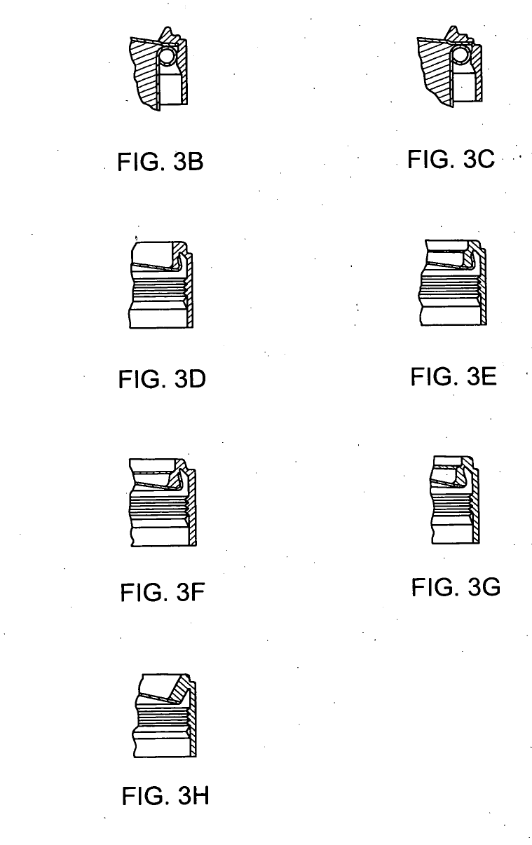

The finger-suspender insert 12 may comprise a single layer or may advantageously include one or more additional functional or decorative layers depending upon the packaging application desired. These are illustrated in FIGS. 3-5 and 11-18.

As shown in FIG. 3, and referring also to FIG. 2, the finger suspender insert 12a is comprised of a single layer of sheet material of suitable strength, comprising an outer annular flange or rim portion 18 defining the circular periphery of the insert, the root region R of a cantilevered suspender integrally joined to this rim portion, the two being a continuation of the same material. In some cases the thickness and geometry of the suspender and the stiffness of the material of which it is formed is sufficient to maintain the cantilevered suspender element 16 in the region of the plane of the flange 18 during automatic handling of the piece, and of the completed suspender unit. Depending upon the anticipated weight of the container to be finger-supported, this insert 12a may for instance be formed of selected weight or thickness of paper, card or chip board stock, reinforced coated papers, flexible woven, knit or nonwoven materials or plastic resin such as high or low density polyethylene or polypropylene in sheet, film or molded form. The form of insert 12a may be created by die-cutting from preformed sheet or film stock. Alternatively, the finger suspender insert 12a may be injection molded, vacuum formed, or formed by other well-established forming techniques suitable for the material selected.

In preferred embodiments in which it is desired that the lid form a seal for goods in the container, a continuous sealing layer is included beneath the finger suspender 16.

As in FIG. 3a, a continuous sealing layer 22 is applied to the completed ring or to container 24 before the completed ring is applied. In other advantageous arrangements, a sealing layer is incorporated in the suspender insert and is joined to the rim as by insert injection molding with the suspender to form a resealable lid. Examples of these will now be described

Referring more particularly to FIG. 3a, shown in cross-section is a completed ring and suspender unit. A molded snap ring 20a of known general form is injection molded about the margin 18 of the pre-formed suspender insert 12a. As shown, the ring 20a is in the form of a snap ring that has an inwardly protruding circular formation 21, constructed to resiliently engage and snap over a slightly larger mating circular formation 24a of container 24, in manner well known.

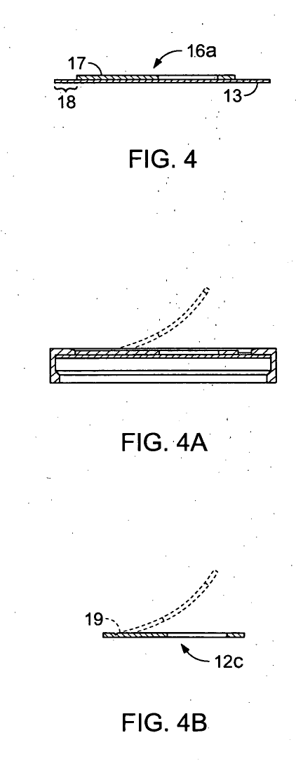

According to known techniques, preferably the cross-section profile of the ring 20a has integral upper projection 23a or upper and lower inwardly extending annular projections that are molded against and thermo-adhesively adhered to corresponding upper or upper and lower surfaces of annular portion 18 of the preformed suspender insert 12a as a result of the insert injection molding process. One such system for forming such lids per se is shown in greater detail e.g. in U.S. Pat. No. 5,647,501, the contents of which are incorporated herein by reference. FIGS. 4c through 4i, drawn from that patent, illustrate the types of integration possible by such insert injection molding.

In embodiments employing this construction, a continuous sealing layer 22, shown in dashed lines in FIG. 3a, is also disposed beneath the finger suspender16 to seal the interior of container 24. In certain embodiments this sealing layer 22 is adhesively applied, e.g. by heated die or induction techniques, to provide a removable tamper-evident member directly to the top of container 24 after filling the container, according to known techniques. The sealing layer may be arranged to be removed by the user before accessing the container's contents.

In other cases, the layer may preferentially adhere to the lid, and be removed from the container on removal of the lid, to be available to reseal the container.

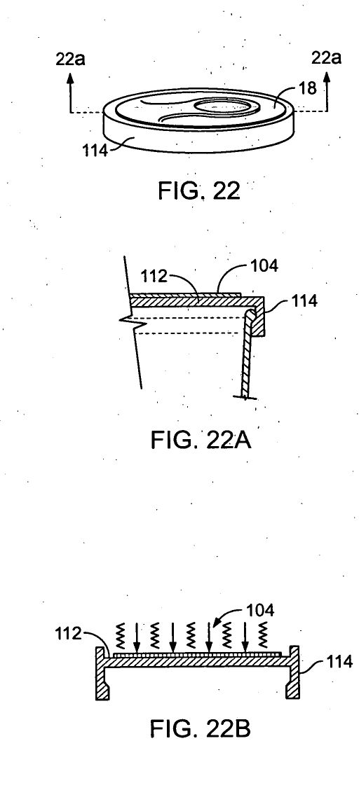

In other embodiments, the sealing layer 22 is inserted into and sealed to the underside interior of the ring 20a to which it is permanently joined as a separate operation after the ring has been molded, as described later on in connection with FIG. 22b. In some cases this can be done while at the ring molding station while the top part of the ring still resides in and is positioned by its mold, or by a robot that removes the ring from the mold, and therefore preserves the unit under positive positional control.

According to another important feature of the present invention, a complete closure or seal layer is provided by features of the construction of the suspender insert unit itself.

Referring to FIGS. 4 and 4a, in one such case, insert 12b comprises a single continuous disc 13 of material such as coated or plain paper or card stock, metal or oriented film such as clear polyester. Additional barrier layers may include vacuum metalized treatments and PVDC or other coatings. In the case of FIG. 4, the material of disc 13 is selected to have sufficient strength to bear the weight of the container and its anticipated contents, while, if to form a hermetic seal, the material of disc 13 is also selected to have the desired moisture and gas barrier properties for the respective packing needs. To the upper surface of disc 13, inwardly of annular margin or flange 18 at the outer periphery, is attached an independently formed hinged or flexible finger suspender element 16a. The root portion 17 of this element lies upon and is secured face-to-face to the top surface of disc 13 at a load-transfer joint as by thermoplastic adhesion see FIG. 22b, or by thermostaking or ultrasound heating or by molding in place, or use of adhesive as by pressure sensitive, curable thermoset resins which are then cured, etc. In some cases, e.g. insert 12c, FIG. 4b, a reduced cross-section thickness of the finger suspender at 19 extends across the width of the base of the elongated, flexible suspender element 16, to form a living hinge adjacent the attachment ring of the suspender unit. In other cases the thickness and nature of the suspender material is selected to provide sufficient flexibility to the suspender itself to deflect to the position of FIG. 2a, or a combination of these two effects is employed. The remainder of the finger suspender 16, i.e. its extended leg 21 and its distal head 23 that defines the finger-receiving opening 11 projects as a cantilever, movable about hinge 19, and/or it generally flexes between the orientation indicated by solid lines in FIG. 4b in the plane of the sheet to the generally upright suspending position of FIG. 2a, see also dashed lines in FIG. 4b.

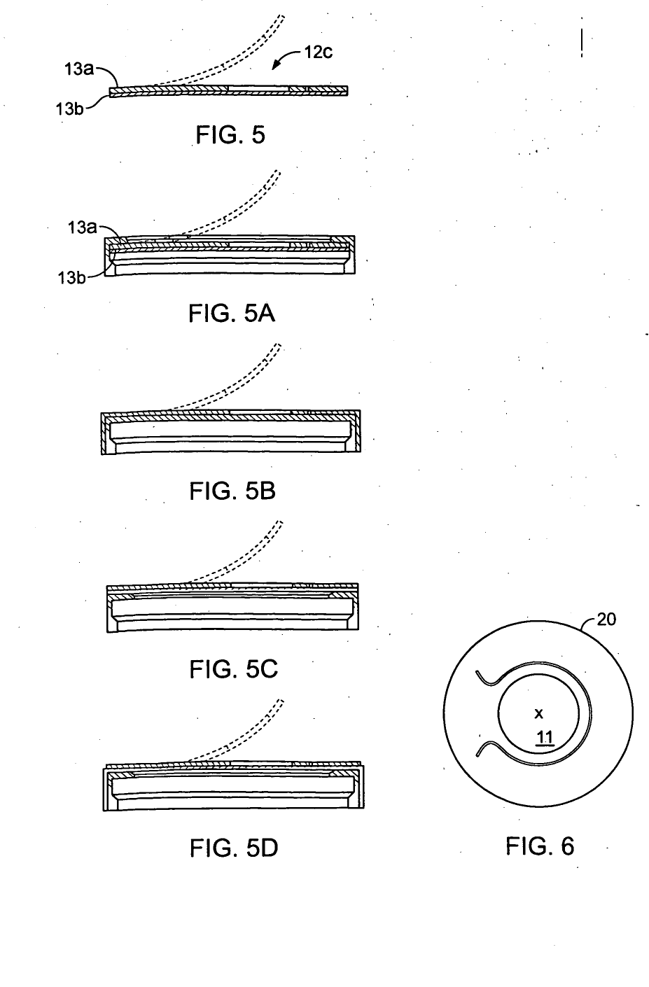

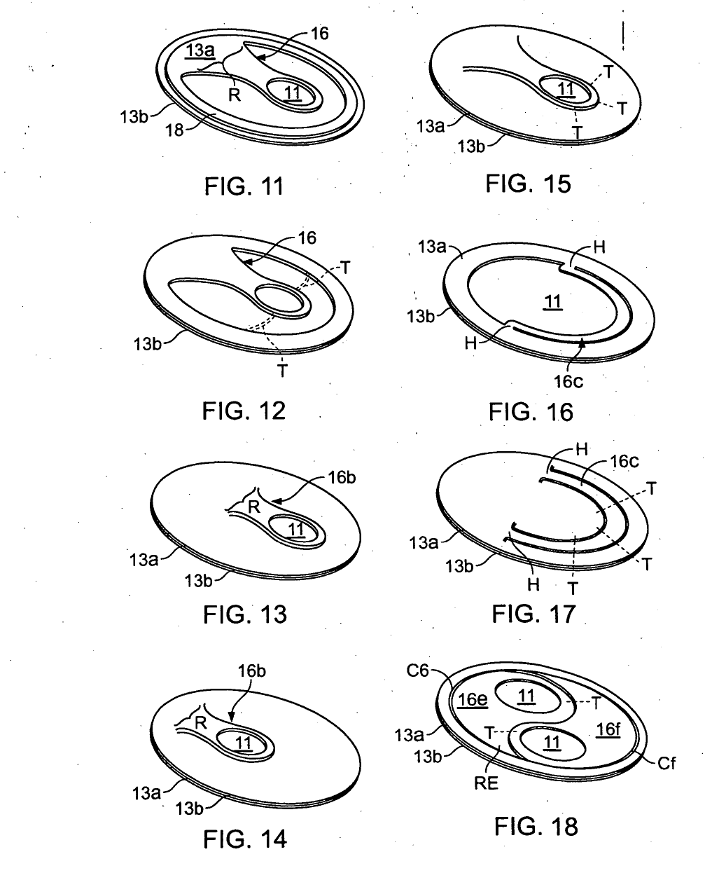

Referring to FIGS. 5 and 5a, as well as the top-most portion of FIG. 1 (and see FIGS. 11-17), in other preferred embodiments, the insert unit is formed of two discrete discs 13a and 13b that may be joined face-to-face at their over-lapping, peripheral margins 18. The upper disc is of material selected to form the deflectable finger suspender to support the weight of the container transferred via the attachment ring 20a. For instance, as mentioned above, ring 20a may be a snap ring as shown that is constructed to snap about an upper bead of the container, or may be sized and shaped to be supported to make a secure friction fit with a matching wall portion of the container, etc.

Referring still to FIG. 5, the material of the lower disc 13b is selected out of consideration of the closure or sealing needs for the container, its needed strength being reduced by the reinforcing effect provided by margin 18 of the upper disc 13a which is face-to-face with margin 18 of lower disc 13b. In some embodiments, the two elements 13b, then 13a, are sequentially inserted into the mold, as suggested by the leftward example of FIG. 1, while in other cases, for instance in cases where one of the elements is not self-supporting, the two are first joined at their margins 18 and then placed in the mold as a single unit as suggested by the rightward example of FIG. 1 and by FIG. 1a.

An important feature of the invention is that the sealing layer or element of any of the embodiments described (22, FIG. 3a; 13b, FIG. 4; 13b, FIGS. 1, 11-18) is advantageously of transparent material to make the contents of the container visible through finger opening 11 of finger suspender 16, or through the open spaces surrounding the finger suspender as in FIGS. 11 and 12. In certain cases it is advantageous that the shape and location of the finger opening 11 be specially constructed and positioned, for instance, enlarged and strategically centered to facilitate viewing of the contents as shown in FIGS. 6 and 16. In those cases, finger opening 11′ and 11″, respectively, are bound by a circle of diameter much in excess of that of an adult finger, preferably centered on the center of the attachment ring. This enlargement facilitates viewing of the container's contents while still providing a suspender of appropriate strength to carry the weight of the container. Likewise such an opening can provide visual access to printed information or design features provided on a surface of the sealing layer, e.g. on its inner or outer surface, or a mid-surface if of multi-layer laminate form, see members 22, 13b, etc.

In some instances, the materials of the suspender element and the sealing layer or element have the same color, to contrast with or to match the color of the molded attachment ring so that all three components appear visually as an integrated single unit. In other cases, the fact that there are three different components forming the ring is taken advantage of by selecting different materials of different color or characteristics to create desired visual or functional effects.

Automatic handling is often desirable for the finished suspender unit. Depending upon the materials selected, the stiffness of the suspender element 16, itself, is sufficient to maintain the suspender in position relative to the ring of the unit to permit automated handling. In cases of a more flexible suspender element, according to the invention, provisions are made to ensure proper positioning of the suspender during automated handling by providing weak, rupturable retaining tabs, filaments, tack weld or adhesive spots at selected positions T, FIG. 2, 11-18 to join distal portions of the suspender to adjoining portions of the surrounding material for holding the suspender in position during such handling.

The tabs or filaments can be formed as mold runners designed into a mold for molding the disc 12a, 13a if the discs are formed by injection molding. Such runners provide advantageous melt flow pathways to enable good filling characteristics for the mold cavity during injection molding. In die-cutting the form of the suspender from preformed sheet stock, the cut-lines may be interrupted at strategic positions likewise to form temporary tabs or filaments at, e.g. positions T, FIGS. 2, 11-18.

When there is a layer below the suspender element, and of particular use when the suspender element is applied at its root at a load-transmitting joint to a preformed disc, per FIGS. 4 and 4a, or FIG. 11, the distal end of the finger suspender is tack-welded or adhered at selected rupturable spots to the underlying disc to hold the suspender in its original plane during automatic handling of the lid.

In any of these cases, in the final automated step of aligning or stacking the lids into a stack for automated feeding, or later, at the filling plant after the lids are applied to their containers, or during arranging of the merchandise for display at a retail establishment, a final step is preferably performed, of dislodging the distal end of the suspender, to rupture the temporary tabs, filaments or weld or adhesive spots and set the distal end of the suspender above its as-formed plane to better position it for grasping. This may be done with automatic equipment by vacuum-lifting the suspender to break the restraint and set the suspender upwardly, by severing the restraint with a suitable automated kiss-knife mechanism that lifts the suspender, by laser cutting, by mechanical prying or by other techniques, as by hand by the rack hangers or shelf-stackers at a grocery or convenience store, etc.

By such actions, the container can be caused to reach the consumer with the finger suspender dislodged and slightly or fully lifted upright, ready to be grasped by a finger of the consumer. In other cases, the finger suspender is advantageously delivered flat to the consumer, and the consumer is enabled, at the consumer's option, to readily lift the suspender free from the temporary restraint if and when the functionality of the finger suspender is desired.

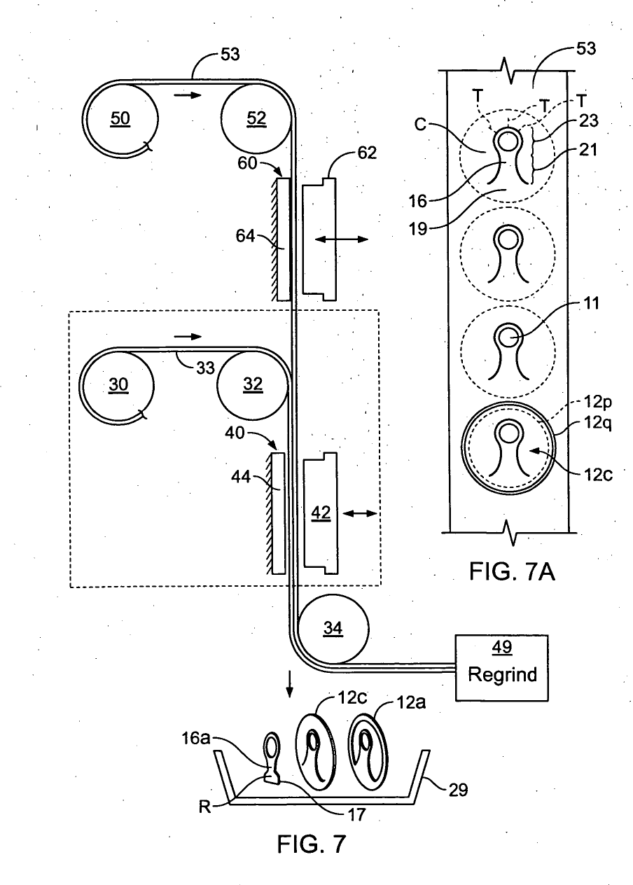

FIGS. 7 and 7a illustrate an advantageous system and method for forming the single layer finger suspender insert of FIGS. 3 and 3a, the suspender element alone of FIGS. 4, 4a or the double layer insert of FIGS. 5 and 5a, and FIGS. 11-17. Such inserts are useful for the insert injection molding that has been described, or, with suitable sizing, may instead comprise members that are integrated with preformed attachment rings or lids.

Referring to the portion of the system outlined by the dashed-line box in FIG. 7, the system includes a first supply roll 30, delivery roll 32 and waste diversion roll 34. Between delivery and waste diversion rolls 32, 34, is mounted a die unit 40, the configuration of which is convertible depending upon the type of product desired, examples of which will be given below. In general it may include reciprocating die member 42 and fixed anvil 44.

Waste diversion roll 34 leads to grinder 49 for regrinding the scrap.

For a more versatile system, a similar second supply and die system is located upstream of this first system, comprising supply roll 50, delivery roll 52 and die unit 60 comprising reciprocating die member 62 and fixed anvil 64.

For forming the single layer suspender insert 12a of FIGS. 3a and 3b, the system outlined in dashed lines in FIG. 7 is employed. A running length of material 33 suitable for constituting the suspender 12a is provided at roll 30. The die 40 is configured as a simple cutting die which, in one cutting motion, cuts, e.g. with double cuts, the formation of the finger suspender as shown in FIG. 2 and its clearance space C from the remaining body of the insert. At the same time the die cuts the finger-receiving hole 11. It also cuts the outer periphery of the rim of the insert to appropriate shape for the mouth of the container for which it is intended, i.e. circular for circular-mouthed container, or square or rectangular with or without rounded corners, oval, etc. for mating containers with such mouths.

The continuous web 33 from roll 30 advances past die 40 to waste diversion roll 34, at which point the suspender 16 with any surrounding elements falls to a receiver 29 while the remaining body of the continuous web turns and moves to grinder 49 where it is reground. If the material is synthetic resin, the reground material is supplied to an extruder for forming additional web 33, or for forming the ring 20a or for another use.

To form the two layer finger suspender insert of FIG. 5, the material 33 provided at roll 30 is the material that is to serve as the lower layer 13b, which may for instance be a transparent polyester film or other transparent food packaging resin or multi-layer laminate, where transparency is important, or coated paper stock carrying printing to be read through opening 11 of the finger suspender, etc.

On supply roll 50 is provided the preformed sheet 53 from which the finger suspender is to be fabricated, e.g. high or low density polyethylene, polypropylene, or, where weight of the container and product permits, suitably coated or reinforced chip board, flexible nonwoven or other textile material or the like. It is advantageous that at least one of the mating surfaces of the two materials be of heat-activatable thermoplastic adhesive, either as a hot melt coating on the layer or as a constituent of the layer itself. Referring to the diagram of FIG. 7 and the web plan view of FIG. 7a, the suspender web 53 is led from delivery roll 50, past die stations 60 and 40 to scrap diversion roll 34, where the remaining web flows to grinder 49.

At die station 60 a die cut is made, similar to that made at die station 40 in the preceding example, i.e. a double cut is made to define the outline of finger suspender 16 (extended leg 21 and distal head 23) and to provide clearance C from the surrounding material. When appropriate, as described above, the cuts are interrupted at strategic locations to provide temporary rupturable tabs or filaments, or a heated die may form tack welds at T FIG. 2 to connect the suspender to the surrounding material to temporarily retain the suspender in the plane of the material as described above. The die 60 also forms a cut-out to define the finger hole 11 in which a person's carrying finger may be inserted.

For the example e.g. of FIG. 7a the peripheral cut 12p is not made at die 60, though it could be if a final structure such as that of the top layer of FIG. 11 were desired.

The suspender pattern is cut respectively at every repeat length, with sufficient material lying between successive cuts as indicated in FIG. 7a by dashed lines, to permit forming the circular rim 18 or other desired peripheral rim of the insert around each finger suspender.

As web 53 advances past die 60, it is merged face-to-face with sealing web 33 before reaching die station 40.

Die station 40 is constructed to cut the mated pair of layers in the desired peripheral form and, as well, to join the two layers at their over-lapping peripheral margins.

As shown, a double peripheral cut 12p, 12q may be made to ensure that the insert 12c is freed of the web and can fall clear from the remaining material. In other cases, as by vacuum action, the die withdraws the piece 12c from the remaining web and the piece is subsequently discharged by an ejector system, such as ejector pins or a blast of compressed, or by withdrawal of retaining die blades into close-fitting recesses.

In many instances it is preferred that the die at station 40 be a heated die, capable of simultaneously cutting and heat-sealing together the contacting margin 18 outlining the suspender. A bar heater of appropriately shape-mating configuration, e.g. circular, adjacent the knife also may be employed to heat-seal together an annular band in the region 18 to ensure that the two layers form a single edge-aligned unit capable of being handled by automated production machinery for feeding to the mold of FIG. 1 or 1a.

If desired, the die at station 40 may also tack weld the finger suspender lightly to the under-lying area at layer 13b at breakable points T for controllably retaining the suspender in its original plane during further processing.

In another embodiment of a forming system, using only one die, the finger suspender 16a is formed as a discrete, separate unit, e.g. to be integrated with the top surface 27 of a preformed lid having an attachment ring 20a as shown in FIG. 4. In one case supply roll 50 and die 60 are used and the die is configured to make a complete or partial cut-out of the entire form of suspender member 16a, FIGS. 7, 4 and 4a, 36 including its root region R as suggested by dashed lines in FIG. 7a. By a suitable heat molding action the die may also form a depression to form a thinned, “living” hinge 19 spaced from the weldable base 17 of the suspender, see FIG. 4b.

If the suspender element 16a is cut completely free it falls to a receiver 29 as suggested in FIG. 7. However, if it is lightly retained in its parent web, the following die station may be employed to adhere the finger suspender element 16a to a carrying sheet 33 to provide a series of finger suspender elements that later can be appropriately welded or otherwise integrated with inserts or to formed lids already provided with attachment rings. If sheet 33 is to serve as sealing layer 13b, at die 40 the finger suspender element is welded as by a heated die at its root to sheet 33, while sheet 33 is cut peripherally by die 40 to form the unit depicted in FIG. 4 with a thermoweld region 17 providing a permanent load-transferring connection between suspender element 16a (see also dashed lines 17 in FIG. 2) and the underlying disc. The various forms of inserts shown in FIGS. 11-17 may also be formed on the machine of FIG. 7.

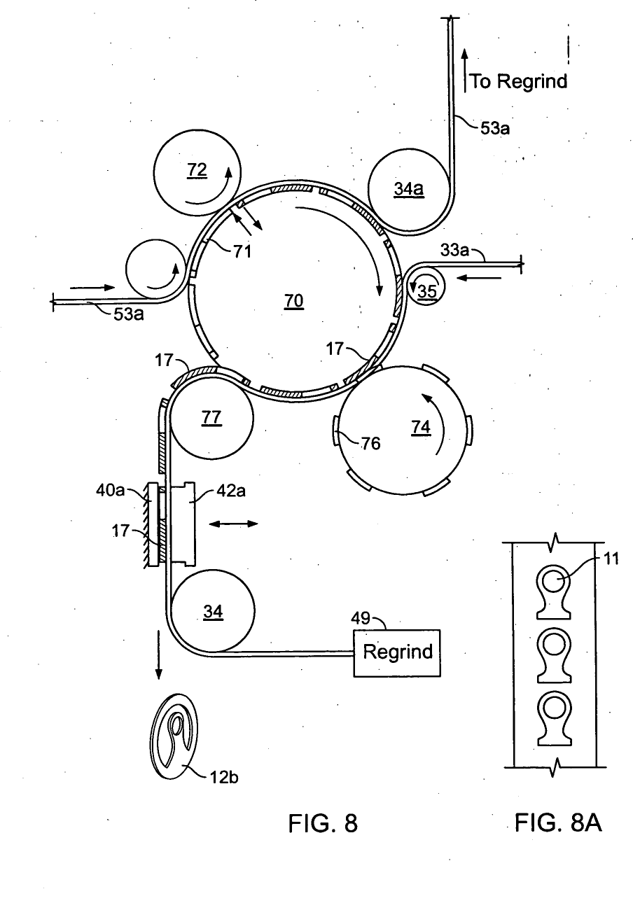

Another machine and process for forming the various insert units is illustrated in FIG. 8, based on a rotary construction.

In the particular process depicted in FIG. 8a, discrete-suspender elements 16a are formed from web 53a at the first die station by projectable and retractable die blades 71 in the surface of die roll 70 acting against anvil roll 72. On further rotation, the cut-out is retained in the respective die 71 while the remainder of the web 53a′ is led as waste by diversion roll 34a to the grinder 49. The continuous web 33a is then introduced to roll 70, and a welding roll 74 which carries welding bars 76 at spaces registering with the bases of the suspender elements form welds at regions 17, permanently integrating the suspender elements 16a to web 33a.

At take off roll 77 the respective die 71 is activated to release its grip on the fastener element 16a which, with the web, travels to die station 40a at which the outer form of the insert 12b is cut free. At waste diverting roll 34 the insert 12b is discharged and the waste remainder 33a′ of the web is led to the grinder.

By corresponding modification of the dies, the apparatus of FIG. 8 may be used for forming inserts 12a and 12c as well. In these cases web 53a moves with roll 70 past waste diversion roll 34a without effect and is mated face-to-face with web 33a at delivery roll 35. In such applications the die 71 of roll 70 withdraws the cut-out for opening 11 of the formed finger suspender but, by suitable construction of the retractable die, the suspender remains in the plane of web 53a as web 53a advances to and past roll 35. For such applications, the dies 71 may be included in roll 72, and roll 70 may serve as the anvil roll. Also, roll 74 may include die members that perform some or all of the final cuts so that die 42a may be simplified or eliminated altogether.

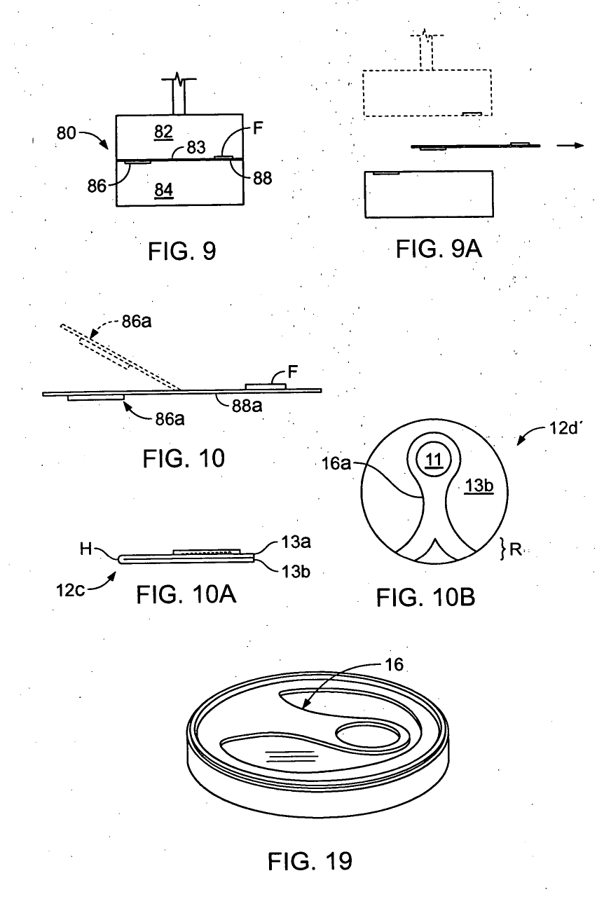

In FIG. 9 and 9a a forming sequence for an insert similar to that of FIG. 5 is illustrated. An injection mold 80 comprises upper and lower mold halves 82, 84 defining a “clamshell” mold cavity of two parts 86, 88 joined by hinge cavity 83. Mold cavity 86 is of the form of suspender layer 13a of FIG. 5 while mold cavity 88 is of the form of sealing layer 13b of FIG. 5. After injecting the resin, the molded part is withdrawn, FIG. 9a. Suspender half 86a is rotated until it matches with and snap-fits with a corresponding formation F of the exposed surface of the lower layer 78a. The root R of the suspender element preferably in the bifurcated form shown in FIG. 10b may be thermowelded to the underlying supporting layer 13b. Thus the completed insert 12c′ is similar to unit 12c of FIG. 5 except for the presence of the hinge H. The hinge may be cut away or incorporated in the molded rim of the attachment ring in the next operation, insert injection molding.

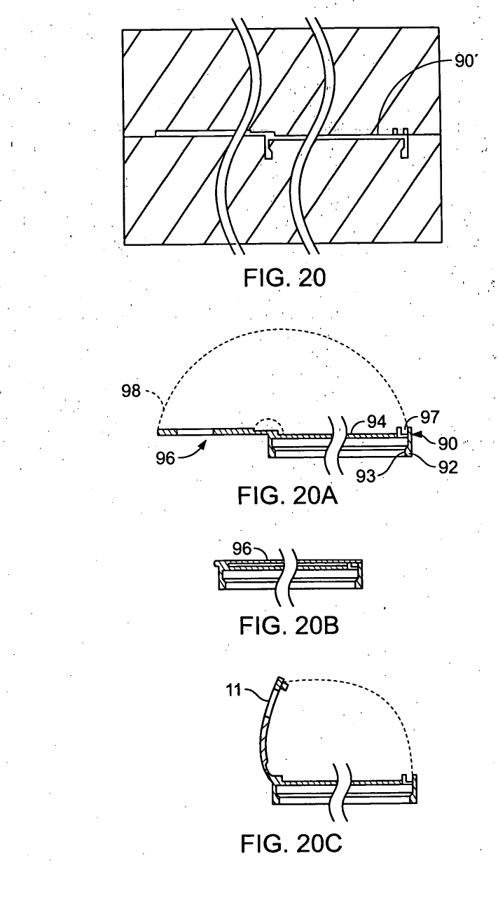

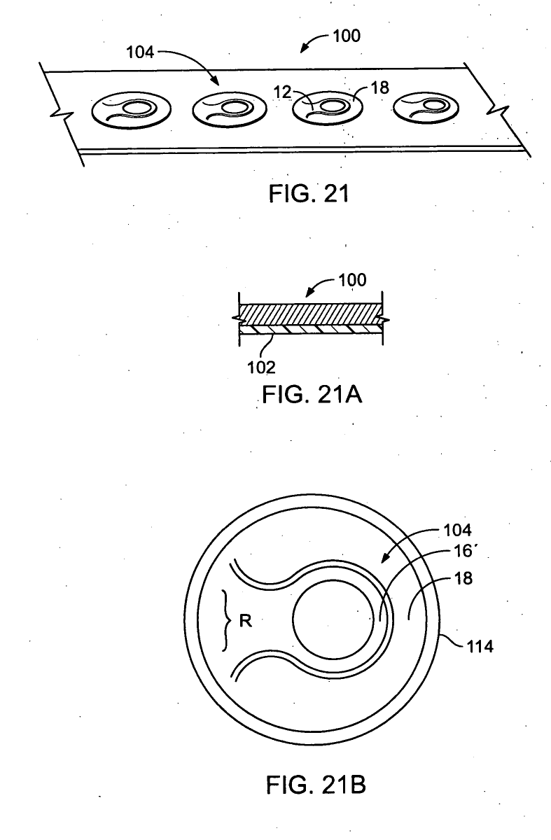

Referring to FIG. 10b, in another clamshell molding embodiment a unit corresponding generally to that of FIG. 4 is formed by clamshell injection molding technique. In this case, finger suspender 16a independent of a surrounding rim is formed in the left cavity 84 of the clamshell mold and the hinge, extending between the two clamshell mold halves is formed to be folded over and lie upon the sealing layer formed by the second mold half, to form the hinge region for the suspender. In the configuration of insert 12d′ of FIG. 10b the hinge is surrounded by injection molded resin of the ring when the ring is formed about the insert. FIGS. 20 and 21 described later employ similar techniques to also form a snap ring, to form a completed suspender unit.

FIGS. 11-17 show a number of preferred forms of suspender inserts, for use in insert injection molding of suspender units, or for serving as inserts to be integrated with preformed attachment rings.

The suspender unit of FIG. 19 formed with the insert assembly of FIG. 11 is an example of a completed unit.

Each of the inserts of FIGS. 11-17 is comprised of two concentric layers, 13a, 13b, the bottom layer 13b providing a seal layer and the top layer 13a providing a deflectable suspender. These layers if constructed to be self-supporting may each be independently inserted into an injection mold in succession as two separate pieces. In such cases, heat-activatable adhesive may be provided on one or both of the in-between surfaces which may be activated by the heat and pressure of the molding operation to seal them together if desired. In other advantageous instances, the elements are first formed and adhered together to form a single insert unit, as by the techniques described with respect to FIGS. 7-10.

Features of the embodiments of FIGS. 11-17 will be mentioned briefly.

In the embodiment of FIG. 11 the lower seal layer 13b is of larger diameter than the layer 13a which forms the deflectable suspender 16. Layer 13a defines the root R of cantilevered finger suspender 16 and an annular supporting rim 18. The suspender 16 is much smaller in transverse lateral extent than the rim 18 and is surrounded by open spaces S. Between the rim 18 and the suspender 16 and through finger aperture 11, the material of lower layer 13b is visible to the consumer, and if of transparent material, provides visible access to the goods within the container, as well as to any printing on layer 13b.

Alternatively, an insert such as 13a of FIG. 11, by being sized of diameter smaller than the ring of a preformed closure lid may be attached at root R and at rim 18 to the top central surface of a pre-formed lid, rim 18 being of assistance in enabling automatic feeding, for instance if the element 13a is an injection molded part. Injection molding may be preferred for providing user-friendly features such as smooth and enlarged finger-engaging surfaces at opening 11, or features corresponding to a desired aesthetic product design.

The embodiment of FIG. 12 differs from that of FIG. 11 only in that the two layers are of the same diameter. The provision of optional retaining strands, tabs, tack welds or adhesive spots for temporarily retaining the suspender at its original plane is suggested by dashed lines T. Such provisions may be employed in all of the embodiments of FIGS. 11-17.

The shortened suspenders of FIGS. 13 and 14 lying in the plane at the upper layer 13a are formed with finger holes 11, to serve as finger suspenders, though in some instances the holes here, as well as in the other embodiments, may be made smaller and serve only as receivers for hanging rods or hooks for display purposes, or larger to provide greater visual access through transparent sealing layers and the like. In the embodiment of FIG. 13 root R is located centrally of the lid, to enable the container to be suspended straight up, as may be desirable for certain sales displays, or for finger suspension of goods or fluids that may tend to leak from a resealed container. In the embodiment of FIG. 14, the root region R of shortened suspender 16b is located close to the periphery, to cause the container to be suspended at an angle for desirable display effects, or for convenience when the hand is also holding other objects. The inserts of FIGS. 13 and 14, as with all of the inserts of FIGS. 11-17, are of circular peripheral form, that can enable automatic feeding if the parts are injection molded, for instance.

The insert of FIG. 15 corresponds to the insert previously described with respect to FIGS. 2 and 5.

The inserts of FIGS. 16 and 17 define bail-like suspenders 16c attached at diametrically opposite flexible hinge regions H. The embodiment of FIG. 16 with a large central cut-out gives large visual access through layer 13b when transparent. In certain embodiments it is advantageous that hinge regions H, indeed the entire layer 13a, be of polypropylene or other material or construction of suitable strength and flexibility to form a living hinge of sufficient strength out of regard for the particular weight planned for the associated container and its contents.

The insert of FIG. 18 defined as a pair of finger suspenders 16e, 16f, formed according to principles previously discussed in our pending PCT patent application referenced and incorporated by reference above. Clearance slots Cₑ and C_{f} enable the respective suspenders to flex about their respective roots Rₑ, R_{f}.

It is to be noted that the embodiments of FIGS. 17 and 18 employ thin clearance slots between the suspenders and adjacent material, making these designs, as well as those of FIG. 15, suitable for including temporary retaining tabs or filaments, e.g. as discussed in relation to FIG. 2, for retaining the suspenders in the plane of their layers until desired to be lifted, and also, in molded embodiments, providing advantageous mold cavity-filling runners.

In other advantageous instances, depending upon types of packaging materials selected, all of the forms shown in FIGS. 11-17 may be manufactured of preformed sheet material, or may be comprised of injection molded or insert injection molded parts e.g. using techniques described above.

The clamshell mold of FIG. 20 is constructed in the same way as the mold for the product of FIGS. 10 and 10a except that the cavity 90′ on the right forms a complete snap lid 90, including both ring 92 having circular formation 93 for engaging the rim of a container and top sealing surface 94. The ring has a detent depression 97 facing upwardly matched with detent 98 molded on the end of suspender 96.

After molding, the deflectable suspender 96 is folded over as suggested by the dotted lines of FIG. 20a to the position shown in FIG. 20b, in which detent 98 enters and is caught in depression 97. This retains the suspender 96 in its folded-down position.

When desired, e.g. after the lid has been snap-applied to a container, suspender 96 is pulled free of the detent, and due to memory of the plastic resin of which it is molded, it self-lifts to an upwardly angled position such as shown in FIG. 20c, ready to be suspended by opening 11.

In certain cases, it is desirable to integrate suspender inserts with preformed structures, to form the completed suspender units. Referring to FIG. 21, a continuous sheet of chipboard stock 100 with a heat activatable undersurface 102 is shown, see cross-section of FIG. 21a. Deflectable finger suspender inserts 104 with circular rims, as previously described, are cut from this material, of the form of FIG. 21b, and integrated with the lid surface 112 of a preformed snap lid, as shown in plan in FIG. 21b and in perspective in FIG. 22. As shown in FIG. 22b, the integration is by heat and pressure applied to the annular margin 18 of the finger suspender insert as well as to root R. As shown in the cross section of FIG. 22a, the rim 114 of the lid is snap fit to the container, the molded lid surface 112 integral with the snap ring 114 forming a seal for the contents, and the finger suspender insert 104 being integrated with the top surface of the lid. The suspender unit is then applied to the merchandise by affixing the lid to the filled container.

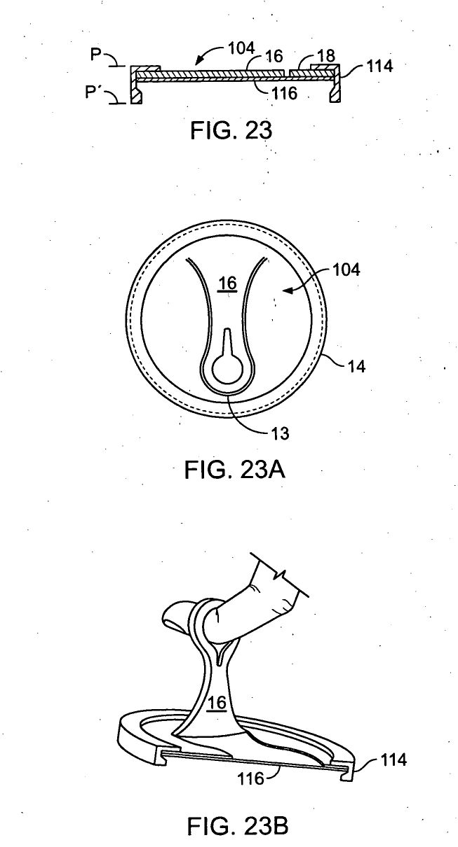

Referring to the embodiment of FIGS. 23-23b, in this case the die cut chipboard finger tab insert is integrated via its upper rim surface with a preformed snap ring 114 from below, within the upper and lower bounding planes P and P′ of the attachment ring 114. This is done again, e.g., by heat and pressure activatable adhesive at the mating surfaces. As shown, the die cut paperboard is also joined face to face, at its lower surface with sealing film 116 lying beneath, the method of joining leaving the deflectable finger suspender element 16 free so that it may be deflected by a finger as shown in FIG. 23b.

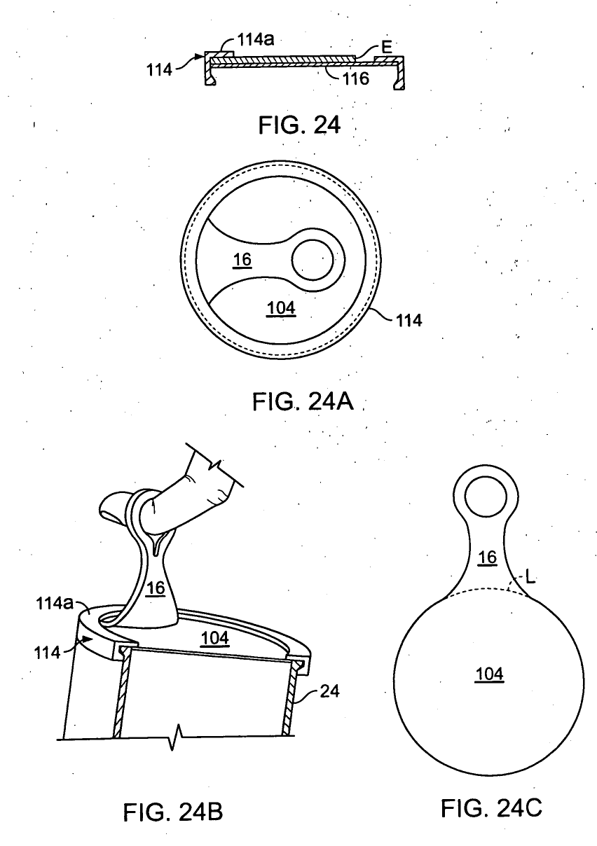

In the embodiment of FIGS. 24-24c, again a chipboard insert 104 is inserted into a preformed plastic ring to complete the lid. As shown in FIG. 24c, the insert in this case comprises a complete circular disc of the paperboard to form a sealing layer, and an outer extension defining a finger suspender 16, that originates in the plane of the disc. This suspender is folded inwardly about the fold line L indicated, and, thus folded; the insert is attached to the underside of the inwardly protruding flange 114a of the plastic ring, with adhesive not shown. As can be seen in the cross section of FIG. 24, the finger suspender extends from one side of the ring to a free end E near the other side. As shown in FIG. 24b, after the lid is snap fit to the container 24, this finger suspender 16 can then be deflected by a finger, as the finger suspends the container 24, as shown.

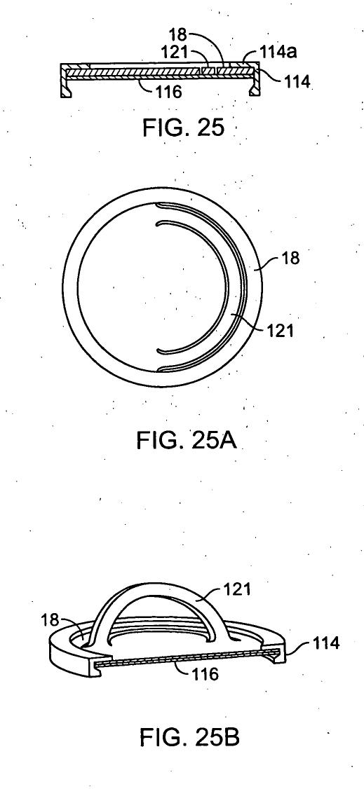

In the embodiment of FIGS. 25-25b, chipboard is die cut to form a flexible handle 121 of half circular shape concentric with its outer rim. This insert again is inserted and adhered to the under surface of the inwardly extending flange 114a of the pre-molded snap ring 114. Sealing film is adhered to the underside of the chipboard, without bond to the handle, to create a seal. As shown in the perspective view of FIG. 25b, the handle 121 can be deflected to suspend the lid and the container, not shown, to which the lid is removably attached.

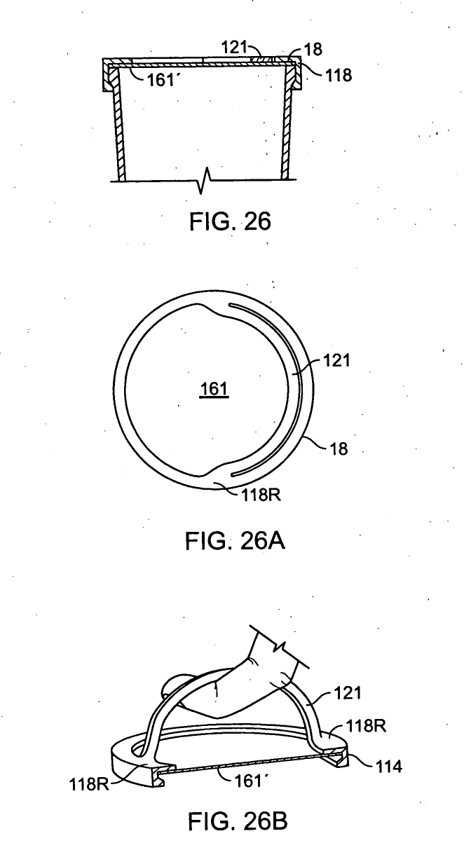

The embodiment of FIGS. 26-26b is of similar construction, except that the large space 161 circumscribed by the inner edge of the bail-like handle 121 and the opposing portion of the rim 18 of the insert, is left open, providing, a viewing area of large dimension, by which the sealing film 161′ can be seen, and with the film transparent, the goods in the container can be seen. The handle 121 is deflectable about root region 118R by a finger to the suspending position of FIG. 26b, but, in the vernacular of the application, this is a bail handle, not a finger suspender as the term has been used herein.

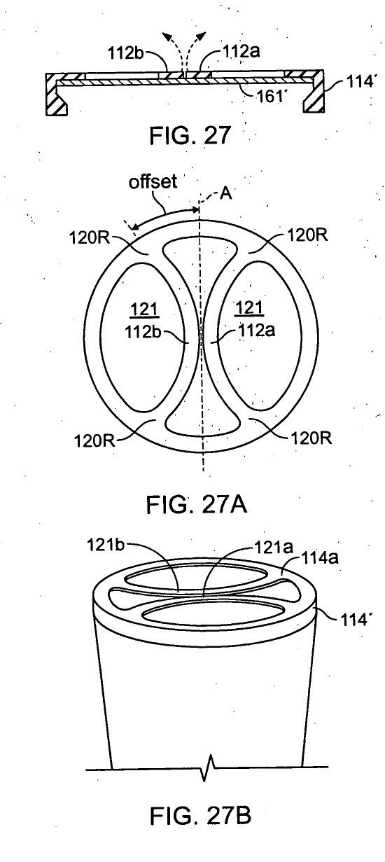

The embodiment of FIGS. 27-27b has two arcuate handles 121a, 121b, molded of plastic integrally with the snap ring 114′, that meet at the center of the lid Axis A, the roots of attachment 120_{R} of these arcuate plastic handles being off-set about 20 degrees to each side from the center diametrical axis A. As indicated by the arrows in FIG. 27, and the perspective view of FIG. 27b, these handles can be deflected to slightly raised and twisted upright positions to support the container. A sealing layer 161′ inserted and adhered to the underside of the inwardly extending flange 114a of the attachment ring provides the sealing layer, and if transparent, provides visual access through the large openings circumscribed by the handles and the rim of the snap ring, as shown.

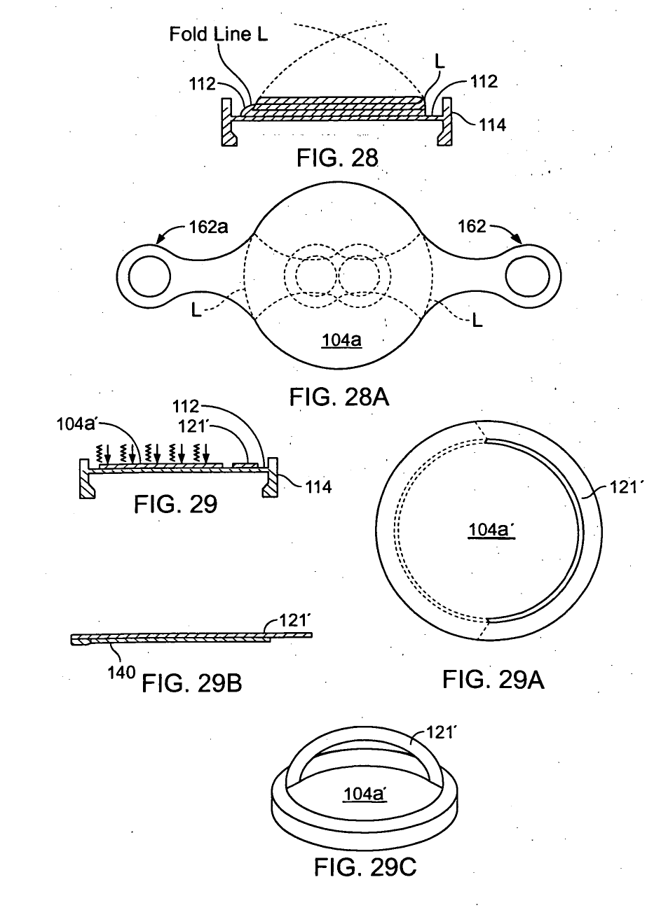

The embodiment of FIGS. 28 and 28a, is similar to the embodiment of FIG. 24 in having a solid central disc 104a of adhesive-backed chipboard, but in this case two diametrically opposed finger suspender extensions 162 and 162a protrude to opposite sides of the disc 104a, and are folded over in overlapping condition, about the indicated fold lines L, to the position shown in the cross section of FIG. 28, within the confines of the molded ring 114. The disc 104a in the embodiment shown is integrated face to face to the upper surface of a molded closure lid portion 112 extending across the snap ring 114. When unfolded in the directions of the arrows, this embodiment provides two suspenders, at opposite sides of the lid, each having an extent longer than half the diameter of the lid, each having a root region L near the ring, an elongated leg and an enlarged distal head that defines a finger opening.

The embodiment of FIGS. 29-29c, has a handle 121′ similar to that of FIG. 25, formed by a suitably die-cut disc of chipboard that is integrated face to face with adhesive, heat and pressure as shown, to the top surface 112 of a preformed lid, the adhesive 140 being omitted in the region of the lift-up handle 121′, so that the handle can move to the upright, suspending position shown in FIG. 29c.

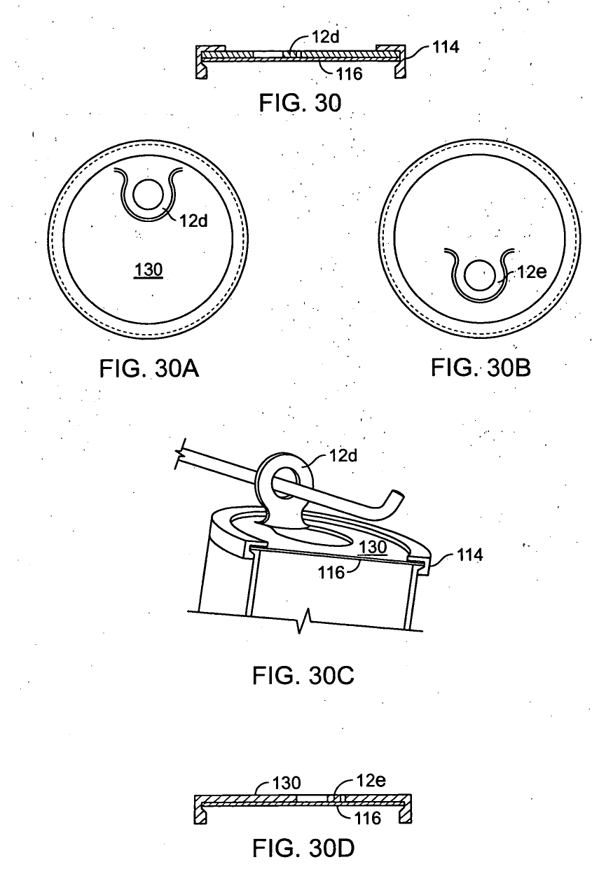

The two embodiments of FIGS. 30-30d show that hangers 12d, 12e which, as formed, lie within the bounding planes of the rim 114, can likewise be formed of die cut chipboard, FIG. 30 and integrated as an insert, or die cut in the substance 130 of a pre-molded lid, FIG. 30d. The hangers can either be located centrally, FIG. 30b, or with root adjacent the molded ring, FIG. 30a. In either case sealing is accomplished by film 116 on the underside as indicated, the film adhered to the insert in areas other than that of the hanger, or to the underside of the molded lid, again, omitting the area of the hanger. FIG. 30c illustrates such a hanging lid supporting a container to which the ring 114 of the lid is snap fit.

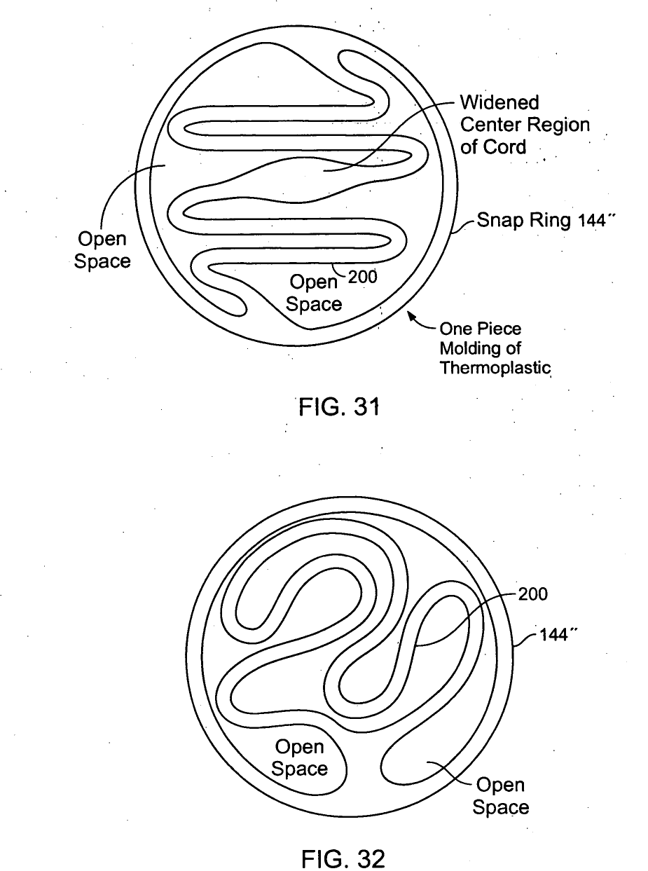

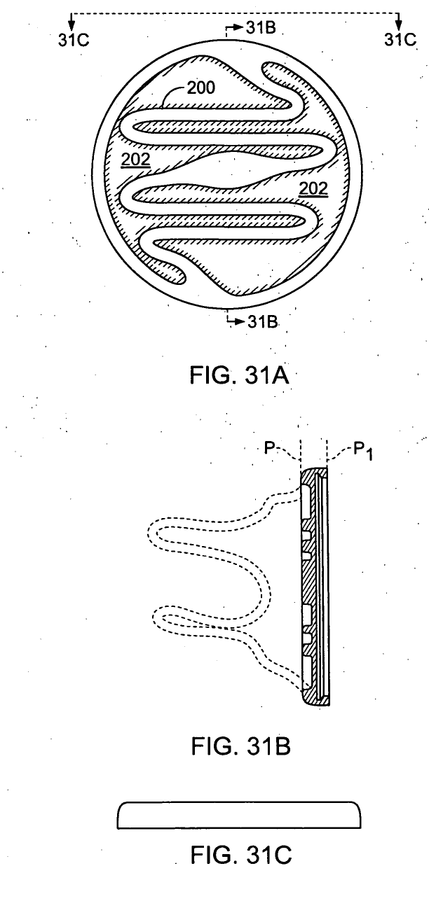

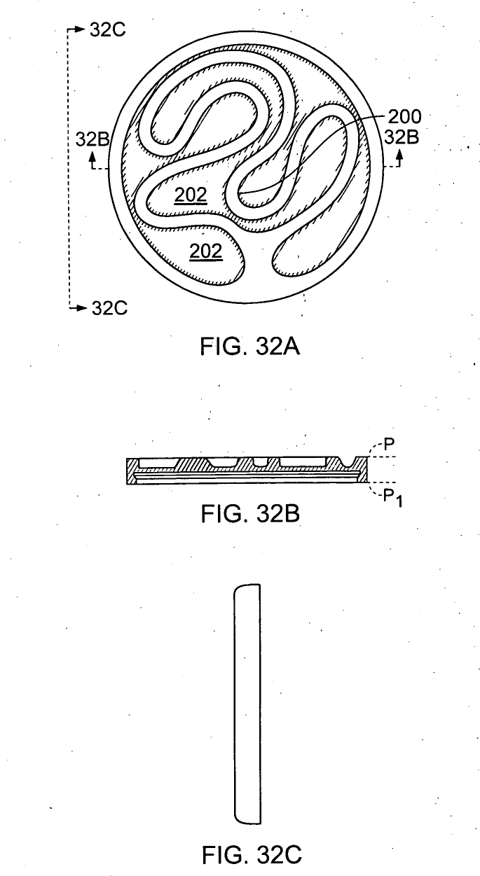

The embodiments of FIGS. 31 and 32 show displaceable suspending cords 200 e.g. of approximately circular cross-section, molded integrally with snap rings 114″ for attachment to containers, and lying within the bounding planes of the snap ring as molded. In both cases the cords 200 are of serpentine configuration, as a one piece molding of thermoplastic, integral with the snap ring 114″. In the embodiments of FIGS. 31 and 32 there is open space between the runs of the cord and between the cord and the snap ring. A circular disc of film adhered at the periphery to an inwardly extending flange of the rim can seal the container across these open spaces. In another case the serpentine cords are molded as a self-supporting insert or supported on the top surface of a disc-form carrier for insert injection molding as described above.

The side profile and cross-section of the snap rings and molded cords of FIGS. 31 and 32 are identical to those of FIGS. 31a and 32a, excepting, in these latter figures, there is further provision of thin rupturable molded membrane sections 202 extending between adjacent runs of the molded cord and between the molded cord and the adjacent surrounding snap ring. In this case the additional sealing film is not required if resealing of the container is not desired or a below-lying sealing layer may be provided as described above.

In any event, in each case, the rupturable membrane maintains the suspending cord in its molded plane during handling, until the user pulls to rupture the membrane and free the cord, see partial distending movement illustrated in dashed lines in FIG. 31b. Provision of the membrane also provides good filling flow paths for the resin to fill the cord cavities during injection molding, another important feature.

In the embodiment of FIG. 31, the cord is joined at diametrically opposite ends to the snap rim, while in FIG. 32, the two ends of the cord are joined to the rim at adjacent roots, on the same side of the ring so that a container to which the unit is attached will hang at an angle.

FIGS. 31 and 31a, each, illustrate a molded cord of approximate circular cross section, but it may be of flat strap forms or other forms and may be formed with zigzag form to provide an elastic effect.

In any of these cases the cord is configured to rest upon a bearing surface such as a finger, a belt loop or strap of a purse, luggage or brief case.

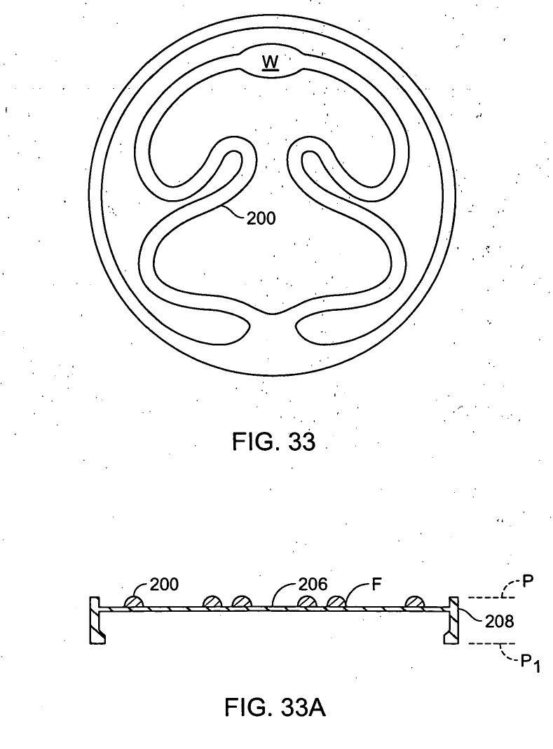

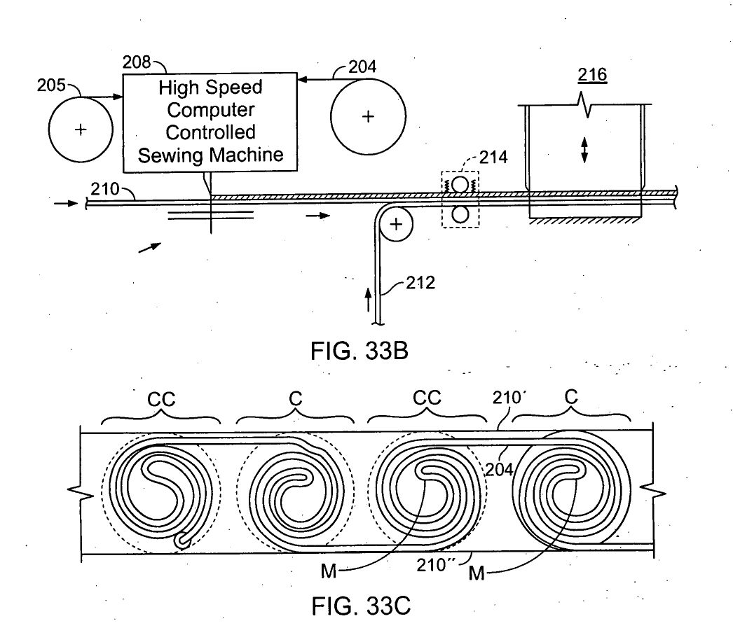

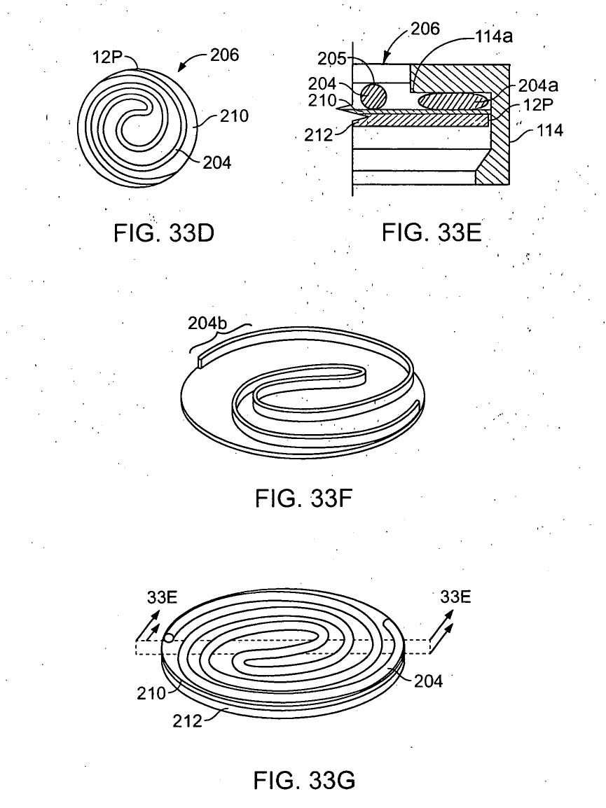

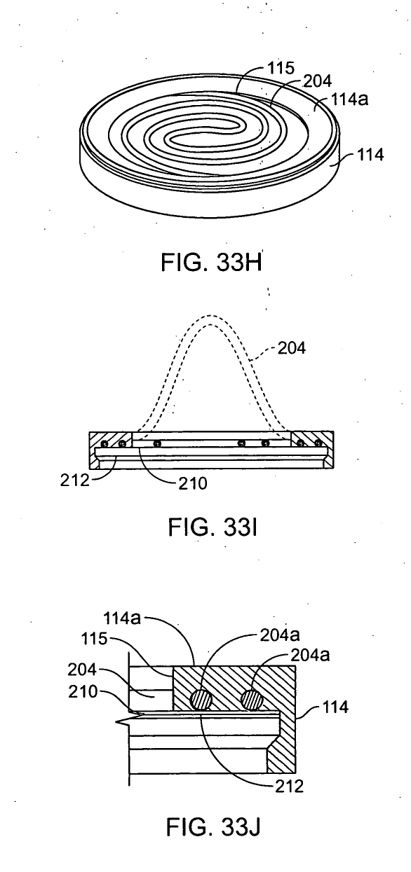

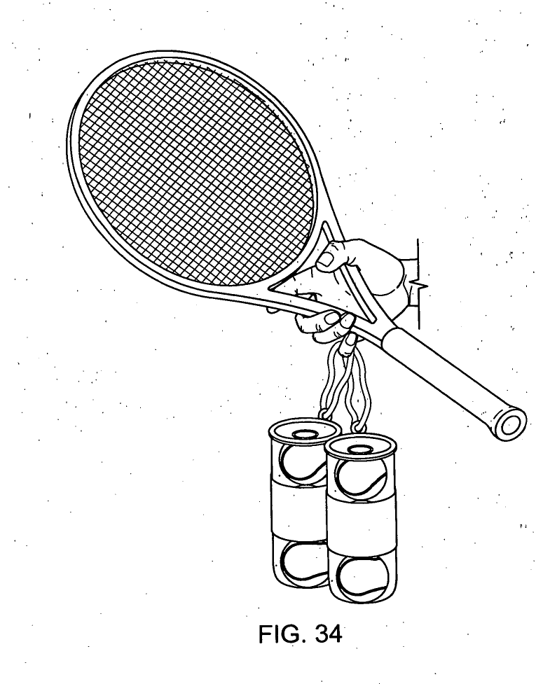

The embodiment of FIGS. 33 and 33a, is similar to that of FIG. 32b, except that the cord configuration is of symmetrical “hour glass” configuration, with a widened center region W of the cord configured to rest comfortably and with wear strength on a supporting finger or object, as shown in FIG. 34. Further, as suggested in the cross-section of FIG. 33a, when formed separately, the cord rests upon a continuous molded lid surface 206 with a frangible contact line F′ that can be ruptured for pulling the suspending cord free while leaving the lid surface 206 in tact, in sealing relationship to the ring 208 and container. The cord can be molded simultaneously with the forming of the cord either as an insert for later forming the attachment ring, or as one piece with the attachment ring, the latter shown in FIG. 33. In another embodiment, the cord 200 may be formed within a rim as an insert, and the rim may be joined to a preformed molded lid, with the cord being lightly adhered to the lid surface for temporary restraint to the plane, for handling purposes as previously described.

FIG. 34 depicts tennis ball cans supported by the supporting cords 200 of the figures.

The cords of FIGS. 31, 32 and 33, are of different lengths, and will demonstrate different twisting behaviors as they are extended from their as-molded condition between bounding planes P and P1. The particular serpentine pattern to be selected, and the size of the arcs of the serpentine pattern are chosen in respect of the diameter of the cord and the torsional, elastic and other physical characteristics of the selected molding resin to provide a desired appearance in their extended condition.

Whereas there are open spaces between the runs of cord in the embodiments of FIGS. 31 and 32, requiring an additional provision for sealing, e.g. a film insert 16 as shown, and described in reference to FIGS. 23 and 25, etc., to which reference is made, the embodiments of FIGS. 31a, 32a, and 33 have thin molded membranes between the runs of cord, which, as previously mentioned, serve to form a complete seal across the top of the lid, until ruptured when extending the cord from the as-molded position.

Referring to FIGS. 33b-j a system is shown for forming, from preformed supporting cord 204, an insert 20b (FIGS. 33b, FIG. 33c) (FIG. 33d) suitable e.g. for insert injection molding to a rim of a lid (FIG. 33, h, i, j) or for integration with a preformed ring to form a lid, FIG. 33e.

In FIG. 33b a high speed computer-controlled sewing machine 208 is arranged to apply preformed product hanging cord 204 for instance a decorative braided nylon cord, to a preformed light-weight carrier web 210, e.g. paper or a non-woven fabric. For this purpose frangible thread 205 is supplied to the sewing machine. As shown in FIG. 33c, for successive inserts, oppositely wound patterns are employed. The pattern at the right, C, is commenced by clockwise spiral sewing action until mid region M is reached, at which point the coil pattern reverses to counter-clockwise movement. The action is reversed for the next insert pattern CC, the pattern being commenced by counter-clockwise spiral sewing action until mid region M is reached, at which point the coil pattern reverses, and so on. Thus it is seen that the cord is arranged so that the points of entry and exit into the coil patterns lie along opposite edges 210′ and 210″ of the pattern, and both the entry and exit segments of the cord are substantially tangent to a circle bounding the coil pattern, at diametrically opposite positions on that circle.

As indicated in the magnified view FIG. 33e, the frangible thread 205 is much lighter in weight than suspending cord 204, and intended only to hold the cord in its pattern during manufacture of the lid and delivery of the product.

Following the sewing machine 208 a web 212 defining a sealing substrate is introduced to the back of carrier web 210. In this embodiment one or both of the mating surfaces of the two webs 210, 212 carry a heat activatable adhesive, and the two are laminated at a suitable lamination station 214, with heat and pressure. The laminate proceeds to die station 216 at which the insert is die cut from the two materials to define outer periphery 12p of insert 206.

As shown in the magnified cross-section FIG. 33e, this insert is laminated to the underside of the inwardly protruding flange 114a of preformed attachment ring 114. Heat and pressure, with suitable bending material compresses the end region 204a of cord 204 as shown, firmly anchoring the cord to ring 114, in manner enabling the weight of the container to be borne by the cord 204 via this joint.

In the case of insert injection molding, see FIG. 1, the insert with the reversed coil pattern of cord, FIG. 33g, has its end regions 204a embedded in the resin of inwardly extending flange 114a of attachment ring 114 with the releasable cord emerging, in this case through vertical inner edge 115 of flange 114a.

FIG. 33c illustrates use of cord 204 to suspend the flat lid and the container (not shown) to which ring 114 is attached. The frangible thread 205 is so selected and applied that it breaks and releases cord 204 from its storage pattern, to its suspending position as suggested by dotted lines.

The embodiment of FIG. 33f illustrates that the cord, may in fact be a strap i.e., having a height in the direction of the axis of the container greater than the thickness, as much as two or three times, and may have a rectangular cross-section. Such a strap enables tight compaction and hence a long extent. (FIG. 33f, for purposes of illustration shows only a minimal length, but for the same size and given the ability to increase the height and reduce the thickness of the strap, a strap many times greater in length is achievable over what is achievable with a round cross-section cord.

Such a strap may be integrated with attachment rings in the manner previously described with respect to preformed rings as well as insert injection molded rings. In other cases, end regions 204b of the strap may be welded or joined to corresponding vertical formations of a preformed ring or a ring being injection molded, for example vertical surface 15 of FIG. 33j.

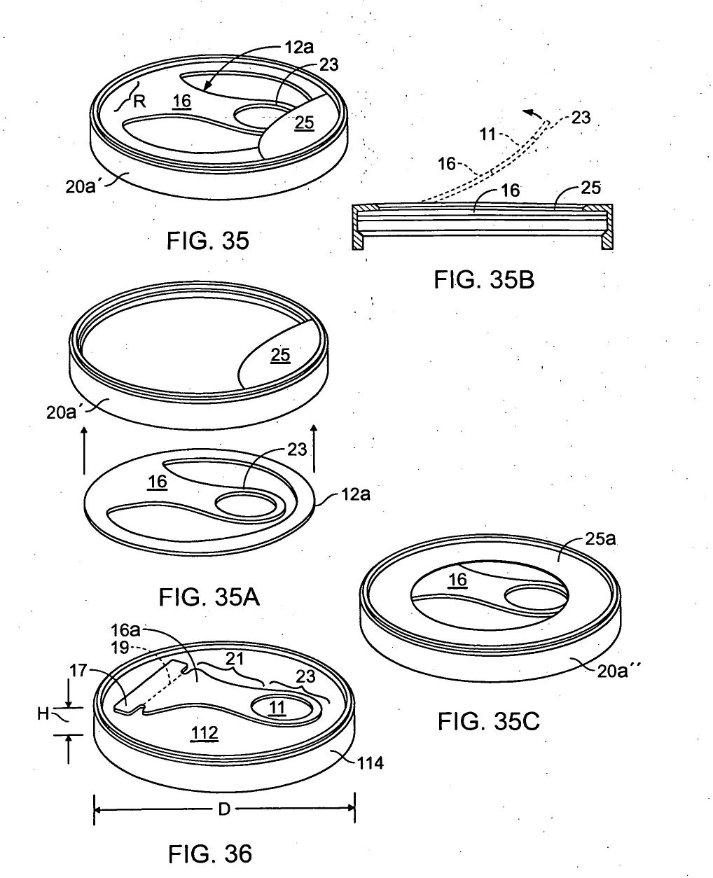

The embodiment of FIGS. 35-35c illustrate novel restraining ledges 25 and 25a constructed and arranged relative to suspender 16 of insert 12a, to temporarily restrain the suspender within the top and bottom horizontal planes of the suspender unit.

Referring to FIGS. 35-35b, ledge 25, protruding inwardly from the attachment ring, is of limited arcuate extent, and is aligned with head 23 of finger suspender 15. Ledge 25 has sufficient inward extent that it overlies the distal end of head 23 and prevents its rising. Release is achievable by flexibility of the material of the suspender. The user, by frictionally engaging the suspender and simply moving toward root region R, causes the suspender to buckle and shorten sufficiently to enable head 23 to move clear of the ledge and to flex toward this supporting position as shown in FIG. 35b.

The embodiment of FIG. 35c differs from that of FIGS. 35-35b, in that the ledge 25a forms a complete annular rim that will retain the suspender regardless of orientation. This has the advantage of enabling simpler automatic feed to the insert 12a to a molding or assembly machine in that no aligning action is required.

Referring to FIG. 36, free formed finger suspender 36 is shown integrated with a pre-formed flat lid (i.e. Diameter D greater by at least about 5 times the height H of the attachment rim 114). The suspender can be made by the techniques of FIGS. 7 or 8 or may be injection molded. It has a base 17 of the preformed lids for instance using the techniques described above with respect to FIG. 22b.

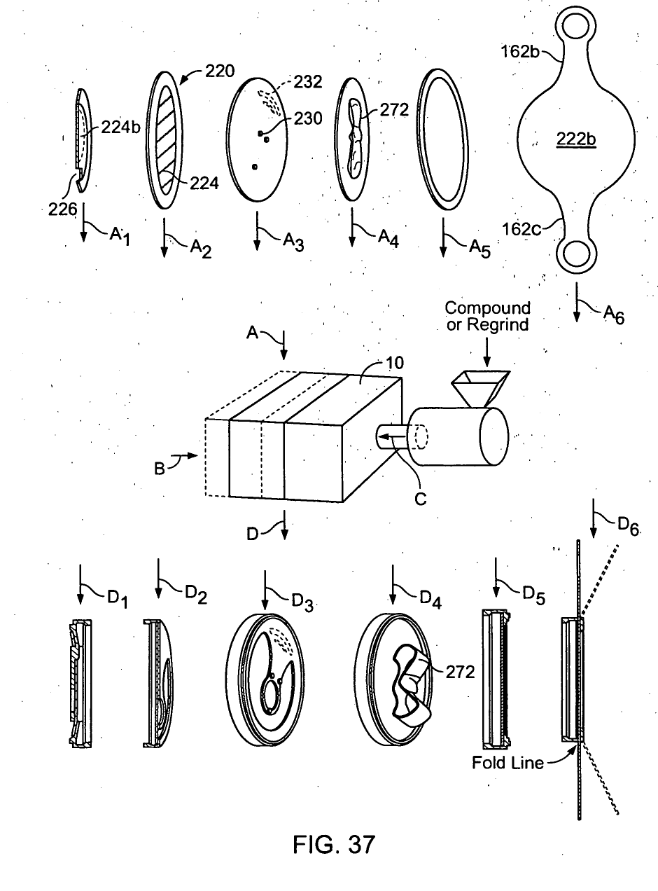

Referring now to FIGS. 37 to 51 other important uses of inserts to form flat lids will be described. Many of these novel techniques and constructions are applicable to both insert injection molding and to application to preformed attachment rings, but some particular techniques are applicable, with great advantage, only to insert injection molding, making that approach a highly desirable way to form inexpensive lids with novel and increased functionality.

FIG. 37 similar to FIG. 1a illustrates examples of the wide range of how functionality that is achievable with novel approaches to insert injection molding of lids. These and other important constructions will be described in detail.

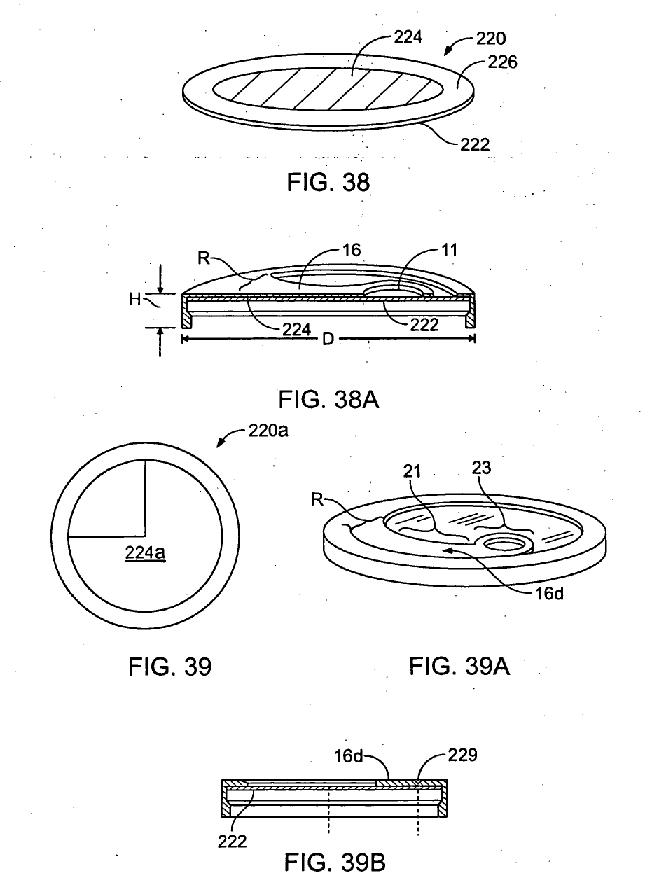

The insert 220 of FIG. 38 simply comprises a circular sealing disc 222 and a co-axial but reduced diameter antibond layer 224 which uniformly covers the central region but leaves a peripheral margin 226 of material compatible to be bonded to the ring material. The antibond layer may for instance be a “seal resist” lacquer or varnish such as referred to in U.S. Pat. No. 4,211,336 and WO 01/44058, hereby incorporated by reference. A particular benefit is realized by employing this insert, as it enables the insert to be joined of its peripheral margin to the attachment ring structure while enabling the finger suspender to be molded directly on top of it, while preserving the liftability of the suspender to its functional position. By employing a full circular pattern, insert 220 can be automatically fed to the injection mold without concern for orientation. The finished suspender unit is similar to that of FIG. 19, except in this case the root R of the suspender is continuously molded with the rim of the lid. Here again the lid can be a flat lid as depicted, with diameter D at least about 5 times the height of the attachment ring.

The antibond material may be chosen to be entirely incompatible with the resin selected for molding the attachment ring and integral finger suspender, however, an advantage is obtainable of temporary restraint, by formulating the material so that there is slight compatibility and slight bonding force created between the molded suspender 16 and surface 224. In this manner the suspender 16 will be retained in its formed position within the bounds of the attachment ring during automated handling and stacking of the lids, attachment to the containers and shipment and handling of the goods—the product awaiting the gentle pull to exceed the design retention force, to enable use of the suspender.

In lieu of a full circle of antibond material, FIG. 38, a selected region as suggested in FIG. 39 may be covered. The embodiment of FIG. 39a makes use of such limited application, by provision of a suspender in “tear loose” form. The finger suspender 16d is of arcuate form, extending about the periphery of the lid for less than 180°. As was the case for the suspender unit of FIG. 38a, the suspender 16d is molded simultaneously with the attachment ring, but in this case it is joined to the ring by reduced section 229, extending along its extent to root region R where the suspender is strongly connected in load-bearing integral relationship to the ring. The frangible connection (tear line) between the suspender to the ring along its length (to the sturdy root R) serves as a temporary restraint of the suspender to its as-formed position along the plane of seal member 222. While general mold design techniques such as those of U.S. Pat. No. 4,211,336 may be followed to advantage in making this embodiment, it is important to note that the purpose and construction of suspender 16d is not to open the container, when tearing it loose to stand as a cantilever; rather, when loose, the suspender remains strongly connected to the lid at root r, to enable the container to be suspended while its seal layer 222 remains in tact, the container still closed.

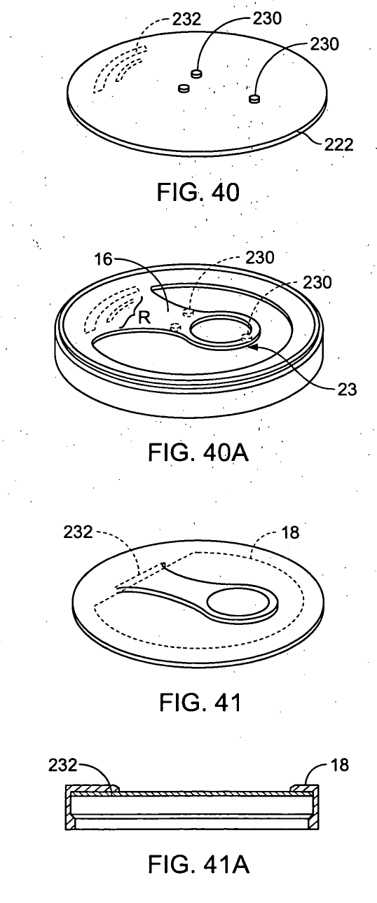

The seal layer 222 of insert of FIG. 40 carries formations 230 of limited extent that enable temporary restraint of the suspender 16, for instance, as shown, three small spots are provided around the rim of head 23. In the case of joining the insert to a preformed ring that carries an integrally molded suspender, formations 230 may comprise slots of heat activatable adhesive. In the case of insert injection molding, at locations corresponding with formation 230, the antibond material 224 (FIG. 38) may be omitted while the remainder of the area under the suspender is covered with the material to avoid unwanted adhesion. In still another case holes may be provided in the layer 222 at the locations of formations 230 to enable plastic resin of the suspender to enter and provide slight mechanical engagement with the sealing layer, when the holes are coated with antibonds or a stronger connection if desired by omitting the antibond.

In FIGS. 40 and 40a the regions denoted 232 also are treated to achieve strong bond of the suspender 16 with sealing layer 222 at root region R of the suspender, to strengthen the joint, where additional load carrying capacity is desired.

FIGS. 41 and 41a illustrate a finger suspender insert, the suspender being die-cut in paper stock along with a slit 232 in the paper in the root region. This slit defines a band region for the suspender; the injection resin of the overlying ring enters this slit, to contribute strength to the region thus defining a hinge. The dashed lines denote the margin of the insert that is joined to the undersurface.

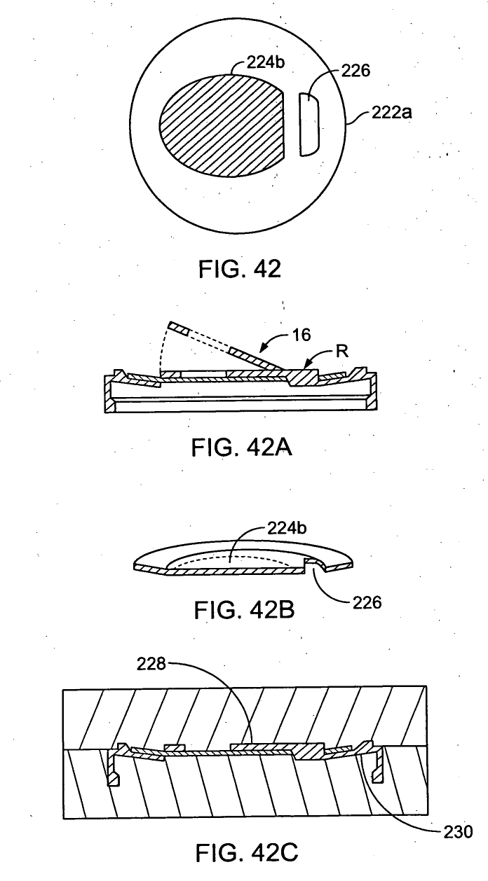

Referring to FIGS. 42-42c, sealing insert 222a has a special flow aperture 226, which, in the mold, communicates from its bottom side with the mold cavity portion 230 forming the attachment ring, or other ring structure, while aperture 226 communicates from its top side with the mold cavity portion 220 that defines the finger suspender 16. The portion of the upper surface of sealing layer 222a underlying the suspender cavity is provided with antibond layer 224b, for purposes described with respect to FIGS. 38 and 39. As seen in FIG. 42a the finger suspender in this embodiment has a thickened root region R, providing a strong load transfer region.

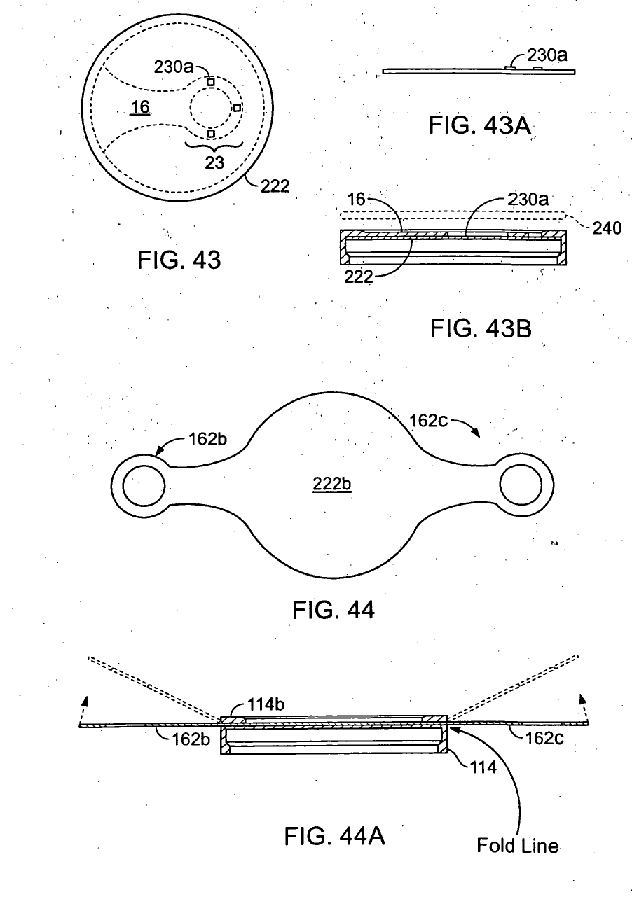

Referring to FIGS. 43-43b, similar to FIG. 40, formations 230a are provided at strategic positions for holding down the head 23 of finger suspender 16. In this case the insert 222 is adapted to be joined to a preformed ring and integrally molded suspender. Formations 230a comprise a composition of thermoplastic adhesive and metal particles such as are employed for instance in U.S. Pat. No. 4,401,231. At the time of joining the sealing insert to the molded ring, the unit is passed by inductor which induces current and heating of the adhesive to effect the frangible bond at points 230a, for temporary restraint of the suspender.

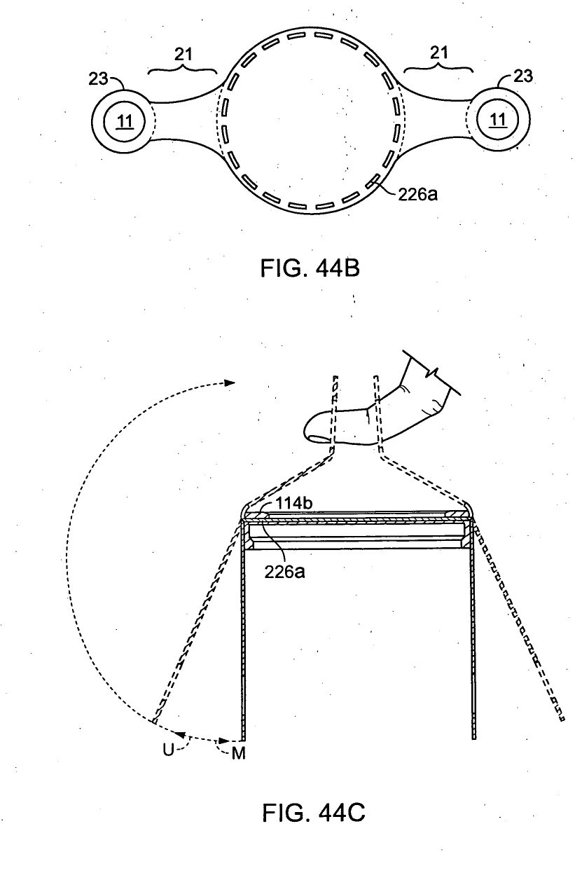

Referring to FIGS. 44 and 44a the sealing insert 222b has diametrically opposite, outlying finger suspenders 162b and 162c, similar to the embodiment of FIG. 28a. The insert of FIG. 44 however is employed in insert injection molding of a flat lid, as shown in FIG. 44a, in which the suspenders protrude beyond the attachment ring in opposite directions. The act of injection molding binds the insert peripherally to the attachment ring 114 being formed, while a ring 114b of molded resin above the insert, stabilizes the insert and contributes to the strength of connection of the suspenders to the remainder of the unit.

Referring to FIGS. 44b and 44c, one important features is a series of resin flow apertures 226a which enable communication and resin joints between the main body of the attachment ring 114 and the ring 114b of molded resin on the upper surface of the unit.

Another feature comprises the provision of discrete bonding regions, denoted by dashed lines, as by reduced cross-section, if of molded material; or limited slitting if of paperboard. Such bond lines are provided at the attachment ring and at the base of the head 23 that defines the finger aperture 11.

An advantageous technique illustrated in FIG. 44c, concerns employing the mold insert action to deflect the suspenders such as to the solid line position shown, e.g. to lie close alongside a cylindrical container to which the flat lid of FIG. 44c is attached. This is a technique used in the early days of forming composite containers, now adapted to novel use in constructing finger suspender units. We refer for instance to U.S. Pat. No. 3,868,893, incorporated herein by reference. When inserting the blank in the mold the suspender extremities are caused to fold in, direction M, as the core of the mold pushes the center portion of the insert into position.

For use, the user bonds the bonded suspender upwardly, and deflects the heads of the suspender as indicated to carry the container to which the ring is attached.

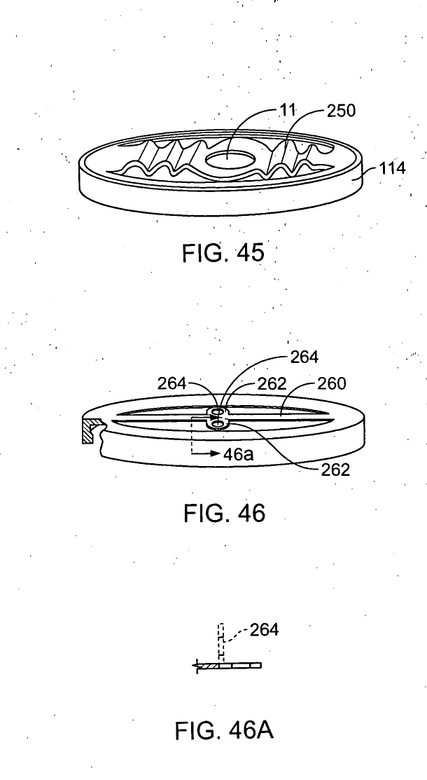

FIGS. 45-49 illustrate other forms of suspenders or hangers that may be formed integrally with the attachment ring. In each case, in most instances, it is understood that a sealing layer is provided under the device, either by insert injection molding or by insertion into a preformed mold, as described earlier.

In the embodiment of FIG. 45, a central strut 250 is molded integrally with the attachment ring 114. As shown, it is molded of undulating form, and hence is distensible to a raised position under load.

A finger opening 11 is provided in the central region, for grasping and extending the strut.

In the embodiment of FIG. 46 a planar central strut extends across a diameter of the attachment ring. From the central region of this strut extend tabs 262 in opposite directions, each defining a supporting aperture 264, sized to receive a supporting rod. As formed, the tabs are coplanar with the strut within the bounding planes of the flat attachment ring. Depending upon the configuration selected, the tabs may flex about a common hinge region at an angle to the axis of the strut, as suggested by dashed lines in FIG. 46, or they may flex about their juncture with the edge of the strut as suggested in FIG. 46a.

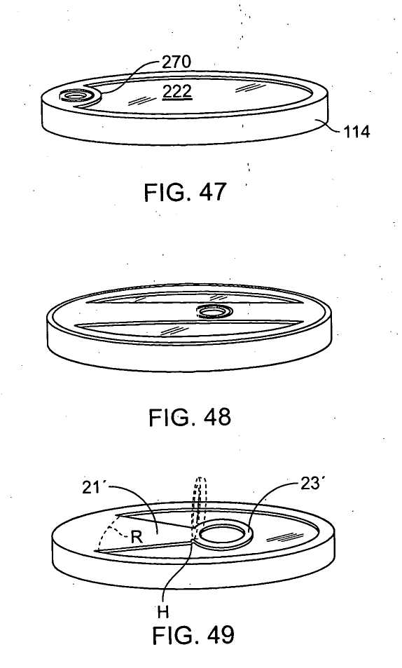

The embodiment of FIG. 47 illustrates that an inwardly extending handing tab 270 may be localized at the attachment ring 114, leaving a large area for printing on a paper sealing insert or the like.

FIG. 48 illustrates a strut similar to that of FIG. 46, but sufficiently wider that a tab is formed in the substance of the strut, as by molding or die cutting in the various manners described.

FIG. 49 illustrates a hinge region H at the base of head 231. In certain embodiments the cantilever shown is flexible along its length and or a hinge is formed at its root R, to serve as a flexible finger suspender as has been described. In some cases where the finger opening is desired to be close to the plane of the lid, neither the length of leg 21′ is flexible, nor is flexibility or hinge action provided at region R, in this case the leg serving as a relatively rigid cantilever.

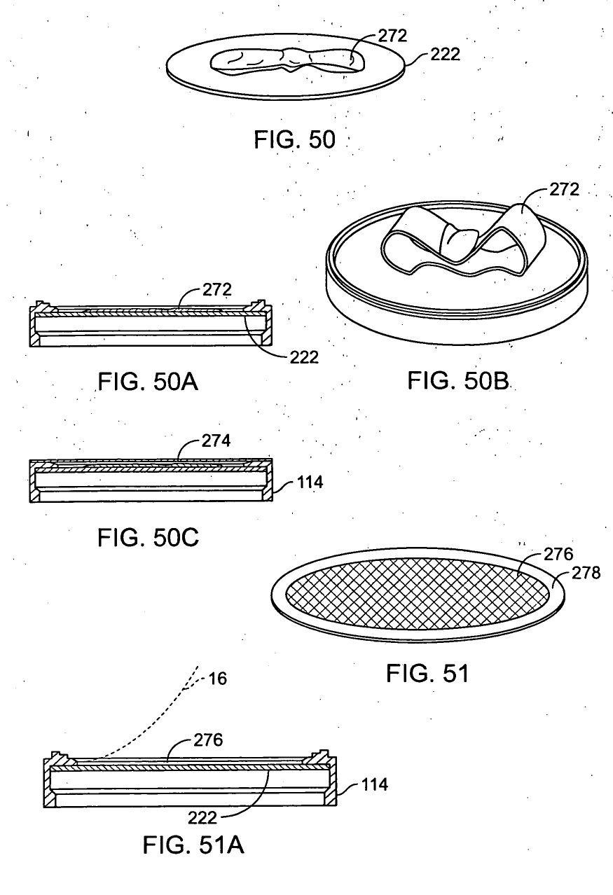

FIG. 50 shows a sealing insert 222 to which a flattened but expansible decorative bow 272 is joined. Suitable detents or adhesive tack points are associated with the expansible bow that it is temporarily restrained to the collapsed condition shown during automatic feeding and handling of the insert and the finished lid. When desired, a gentle tug on the looped ends of the bow cause it to expand to its decorative shape as shown in FIG. 50b. By suitable selection of materials and bonding techniques, the bow may serve as a suspender for the product; and when formed of elastic materials, a suspender distance of e.g. 2 inches is obtainable.

In the embodiment of FIG. 50c, a transparent film 224 closes the top of the attachment ring 114, protecting the bow during transit. In alternative embodiments the protective film or sheet may be a separate insert, or it may be laminated to the insert carrying the bow.

In the embodiment of FIGS. 51 and 51a, sealing insert 222 carries a decorative or informative hologram 276, bounded by a joining margin 278 by which the insert is joined to the attachment ring. As suggested in phantom lines, advantageously a finger suspender is combined with the lid of FIG. 51a as by being molded integrally with the ring, with an antibonding lacquer or varnish comprising the enter hologram surfaces.

### Conclusion

Whereas the lids described have mostly been snap lids, it will be understood that a many of the features of the invention, in their broadest aspects, do not require snap fit to achieve advantages of the invention.

In other embodiments a top member carrying a hanger of suspender as described may be mechanically captured at the rim, instead of being bonded face-to-face to the molded top section. Among useful constructions are the snap fit of a chipboard disc insert into a receiving recess molded into the ring of the lid, and the use of molded deformable retaining formations, which in an assembly operation after insertion of the insert, are deformed with heat and pressure to capture such an insert.

The uses of the lids and containers shown are many and varied, for instance the examples given in the above-referenced pending applications. Amongst many other uses would be a tub container for popcorn having an end directed downwardly, closed by a molded plastic snap lid capable of bearing the weight of the contents of the tub, and a finger suspender integrated with the closed end of the tub. A single finger suspender, a double finger suspender or other hangers or cords as shown here or in the earlier applications may be employed.

An adhesively integrated molded or chip board suspender and joining ring of the various forms shown may be applied to the bottom of an unconventional over-the-counter bottle of spring drinking water that has a widened supporting screw cap for resting the bottle on a surface, on its top. Such a bottle is suited for sports people, the suspender, when deployed enabling carrying the bottle by a belt loop or on the strap of a sports bag, purse or brief case. A similar bottle has a “snap lid” but snap fit to the closed BOTTOM of the water bottle, to enable portability.

Suspenders of the various kinds described, may advantageously be applied to opposite ends of a container, the suspenders then threaded upon a pair of separated upright support rods, one at each end of the product, for display in a store, and employed to carry the article by both ends, or for enabling change of hands during carrying, or for spreading seeds or fertilizer, as through a side slit in a bag so carried, the slit adjusted in metering width by an adjustable hook-and-loop closure strip.

A conventional snap lid may be molded, and a suspender formed by suitable die cutting of the formed closed surface of the lid 11. While the preferred insert injection molding has been shown, it will be understood the ring may be of paper or card stock, formed about, and glued to, the preformed insert, or pulp molding techniques may be employed. Accordingly, other embodiments are within the spirit and scope of the following claims.

It will be understood that conventional resins may be employed for molding those components indicated to be molded, and serving as the sheet material from which the cut outs shown may be formed. Selection of the particular material depends upon the size and weight of the container and the nature of the union between lid and container and the equipment available to the producer. Among useful resins are a wide range of densities of polyolefin's, e.g., high or low-density polyethylene. Polypropylene, polystyrene, PET, etc. are also useful.

A number of embodiments of the invention have been illustrated. It will be understood that modifications may be made out of choice of design or to achieve additional features without departing from the spirit and scope of the invention.

1-84. (canceled)

85. A lid comprising an attachment ring and a suspender element molded together as a unit and joined to a sealing layer by insert injection molding.

86. The lid of claim 85 in which the suspender is weakly bound to said sealing layer for temporary restraint.

87. A lid formed by insert injection molding comprising an attachment ring, a sealing insert molded to the ring, antibonding material on the top surface of the sealing insert and a deflectable suspender molded as a unit with the attachment ring over the antibonding material on the insert.

88. The lid of claim 87 in which a molten resin flow aperture is provided in the insert enabling communication of injected resin between cavity portions defining said molding rim and said suspender.

89. The lid of claim 87 in which the suspender is elongated and disposed within the mounting ring in its as-formed position.

90. The lid of claim 89 in which the suspender is a cantilever.

91. The lid of claim 89 in which the suspender is adjacent to and weakly bound to said attachment ring in a “tear loose” arrangement.

92. A flat lid comprised of a molded ring and a sealing insert carrying an additional functional element such as a suspender, a decorative bow, a hologram or combinations of one or more of these.

93-95. (canceled)

96. The method of making a suspender unit comprising providing a mold defining an attachment ring either the mold or the central member including a suspender inserting a corresponding insert and injection molding said attachment ring about said insert.

97. (canceled)

98. (canceled)
